(19) United States
(12) Patent Application Publication
(10) Pub. No.: US 2015/0334389 A1
(43) Pub. Date: Nov. 19, 2015

(54) IMAGE PROCESSING DEVICE AND IMAGE PROCESSING METHOD

(71) Applicant: Sony Corporation, Tokyo (JP)

(72) Inventor: Kazushi SATO, Kanagawa (JP)

(73) Assignee: SONY CORPORATION, Tokyo (JP)

(21) Appl. No.: 14/410,343

(22) PCT Filed: Aug. 5, 2013
(86) PCT No.: PCT/JP2013/071163

§ 371 Date: Dec. 22, 2014

(30) Foreign Application Priority Data
Sep. 6, 2012 (JP) 2012-196607

(51) Int. Cl. H04N 19/103; H04N 19/139; H04N 19/176; H04N 19/593

(52) U.S. Cl. CPC H04N 19/103; H04N 19/593; H04N 19/139; H04N 19/176

(57) ABSTRACT

There is provided an image processing device including a base layer decoding section configured to decode an encoded stream of a base layer, and to generate a reconstructed image of the base layer, and a prediction control section configured to use the reconstructed image generated by the base layer decoding section, and to control a prediction mode that is selected at generation of a predicted image of an enhancement layer.

### TECHNICAL FIELD

The present disclosure relates to an image processing device and an image processing method.

### BACKGROUND ART

Joint Collaboration Team-Video Coding (JCTVC), which is a joint standardizing organization of ITU-T and ISO/IEC, is currently standardizing an image encoding scheme referred to as high efficiency video coding (HEVC) for the purpose of achieving further better encoding efficiency than that of H.264/AVC. For the HEVC standards, the specification draft 8 was issued in July. 2012 (see Non-Patent Literature 1 below).

Attention centers on scalable video coding techniques that are scalable to diverse capability and communication environments of terminals. The scalable video coding (SVC) is generally represented by the technology of hierarchically encoding layers that transmit rough image signals and layers that transmit fine image signals. The typical attributes hierarchized in the scalable video coding chiefly include the following three:

Spatial scalability: Spatial resolution or image sizes are hierarchized.

Temporal scalability: Frame rates are hierarchized.

Signal to noise ratio (SNR) scalability: SN ratios are hierarchized.

Further, discussion has arisen as to bit-depth scalability and chroma format scalability, which have not yet been adopted in the standard.

The scalable video coding usually reuses parameters to be encoded in the base layer in enhancement layers, achieving better encoding efficiency. Difficulty in mapping parameters between layers, however, imposes some restriction (e.g. a layer does not select a mode that another layer does not support, etc.) on the reuse of the parameters in most cases. The following Non-Patent Literature 2 then proposes a technique referred to as spatial scalability using a BL reconstructed pixel only (BLR) mode, in which only reconstructed images of the base layer are reused to achieve scalability. The BLR mode strengthens the independence of each layer.

### CITATION LIST

### Non-Patent Literature

Non-Patent Literature 1: Benjamin Bross, Woo-Jin Han, Jens-Rainer Ohm, Gary J. Sullivan, Thomas Wiegand, “High efficiency video coding (HEVC) text specification draft 8” (JCTVC-J1003_d7, July 11-20, 2012)
Non-Patent Literature 2: Hisao Kumai. Tomoyuki Yamamoto, Andrew Segall, Maki Takahashi, Yukinobu Yasugi, Shuichi Watanabe, “Proposals for HEVC scalability Extension” (ISO/IEC JTC1/SC29/WG11 MPEG2012/m25749, July 2012, Stockholm, Sweden)

### SUMMARY OF INVENTION

### Technical Problem

The BLR mode, in which only reconstructed images of the base layer are reused in enhancement layers, however, requires a large number of parameters to be encoded in the enhancement layers.

It is thus desirable in terms of encoding efficiency to improve a way of reusing reconstructed images to reduce the amount of codes for enhancement layers.

### Solution to Problem

According to the present disclosure, there is provided an image processing device including a base layer decoding section configured to decode an encoded stream of a base layer, and to generate a reconstructed image of the base layer, and a prediction control section configured to use the reconstructed image generated by the base layer decoding section, and to control a prediction mode that is selected at generation of a predicted image of an enhancement layer.

The image processing device may be implemented as an image decoding device that decodes images. Instead, the image processing device may be implemented as an image encoding device that encodes images. In the latter case, a base layer decoding section may be a local decoder that operates for the base layer.

In addition, according to the present disclosure, there is provided an image processing method including decoding an encoded stream of a base layer, and generating a reconstructed image of the base layer, and using the generated reconstructed image, and controlling a prediction mode that is selected at generation of a predicted image of an enhancement layer.

### Advantageous Effects of Invention

According to the technology of the present disclosure, a way of reusing reconstructed images in the BLR mode is improved, and the amount of codes for enhancement layers is reduced, which may consequently achieve better encoding efficiency.

### BRIEF DESCRIPTION OF DRAWINGS

FIG. 1 is an explanatory diagram for describing scalable video coding.

FIG. 2 is an explanatory diagram for describing a prediction mode set for intra prediction in AVC.

FIG. 3A is a first explanatory diagram for describing a prediction mode set for inter prediction in the AVC.

FIG. 3B is a second explanatory diagram for describing a prediction mode set for inter prediction in the AVC.

FIG. 4 is an explanatory diagram for describing a prediction mode set for intra prediction in HEVC.

FIG. 5A is a first explanatory diagram for describing a prediction mode set for inter prediction in the HEVC.

FIG. 5B is a second explanatory diagram for describing a prediction mode set for inter prediction in the HEVC.

FIG. 6 is an explanatory diagram for describing scalable video coding in a BLR mode.

FIG. 7 is a block diagram illustrating a schematic configuration of an image encoding device according to an embodiment.

FIG. 8 is a block diagram illustrating a schematic configuration of an image decoding device according to an embodiment.

FIG. 9 is a block diagram illustrating an example of a configuration of an EL encoding section illustrated in FIG. 7.

FIG. 10 is a block diagram illustrating an example of specific configurations of a prediction control section and an intra prediction section illustrated in FIG. 9.

FIG. 11A is a first explanatory diagram for describing that candidate modes for intra prediction are narrowed down.

FIG. 11B is a second explanatory diagram for describing that candidate modes for intra prediction are narrowed down.

FIG. 11C is a third explanatory diagram for describing that candidate modes for intra prediction are narrowed down.

FIG. 11D is a fourth explanatory diagram for describing that candidate modes for intra prediction are narrowed down.

FIG. 12 is a block diagram illustrating an example of specific configurations of the prediction control section and an inter prediction section illustrated in FIG. 9.

FIG. 13 is an explanatory diagram for describing a new candidate mode for inter prediction based on a BL reconstructed image.

FIG. 14 is an explanatory diagram for describing an encoding parameter relating to motion vector search using a BL reconstructed image.

FIG. 15 is a flowchart illustrating an example of a schematic flow of an encoding process according to an embodiment.

FIG. 16A is a flowchart illustrating a first example of a process flow relating to intra prediction in an encoding process on an enhancement layer.

FIG. 16B is a flowchart illustrating a second example of a process flow relating to intra prediction in the encoding process on an enhancement layer.

FIG. 16C is a flowchart illustrating a third example of a process flow relating to intra prediction in the encoding process on the enhancement layer.

FIG. 17A is a flowchart illustrating a first example of a process flow relating to inter prediction in an encoding process on an enhancement layer.

FIG. 17B is a flowchart illustrating a second example of a process flow relating to the inter prediction in the encoding process on an enhancement layer.

FIG. 18 is a block diagram illustrating an example of a configuration of an EL decoding section illustrated in FIG. 8.

FIG. 19 is a block diagram illustrating an example of specific configurations of a prediction control section and an intra prediction section illustrated in FIG. 18.

FIG. 20 is a block diagram illustrating an example of specific configurations of the prediction control section and an inter prediction section illustrated in FIG. 18.

FIG. 21 is a flowchart illustrating an example of a schematic flow of a decoding process according to an embodiment.

FIG. 22A is a flowchart illustrating a first example of a process flow relating to intra prediction in a decoding process on an enhancement layer.

FIG. 22B is a flowchart illustrating a second example of a process flow relating to intra prediction in the decoding process on an enhancement layer.

FIG. 22C is a flowchart illustrating a third example of a process flow relating to intra prediction in the decoding process on an enhancement layer.

FIG. 23A is a flowchart illustrating a first example of a process flow relating to inter prediction in a decoding process on an enhancement layer.

FIG. 23B is a flowchart illustrating a second example of a process flow relating to inter prediction in the decoding process on an enhancement layer.

FIG. 24 is a block diagram illustrating an example of a schematic configuration of a television device.

FIG. 25 is a block diagram illustrating an example of a schematic configuration of a mobile phone.

FIG. 26 is a block diagram illustrating an example of a schematic configuration of a recording/reproduction device.

FIG. 27 is a block diagram illustrating an example of a schematic configuration of an image capturing device.

### DESCRIPTION OF EMBODIMENTS

Hereinafter, preferred embodiments of the present disclosure will be described in detail with reference to the appended drawings. Note that, in this description and the drawings, elements and structure that have substantially the same function are denoted with the same reference signs, and repeated explanation is omitted.

The description will be now made in the following order.

### 1. Overview

1-1. Scalable Video Coding
1-2. Prediction Mode Set for Base Layer
1-3. Prediction Mode Set for Enhancement Layer
1-4. BLR Mode
1-5. Example of Basic Configuration of Encoder
1-6. Example of Basic Configuration of Decoder
   2. Example of Configuration of EL Encoding Section according to Embodiment
2-1. Overall Configuration
2-2. Specific Configuration Relating to Intra Prediction
2-3. Specific Configuration Relating to Inter Prediction
   3. Flow of Encoding Process according to Embodiment
3-1. Schematic Flow
3-2. Process Relating to Intra Prediction
3-3. Process Relating to Inter Prediction
   4. Example of Configuration of EL Decoding Section according to Embodiment
4-1. Overall Configuration
4-2. Specific Configuration Relating to Intra Prediction
4-3. Specific Configuration Relating to Inter Prediction
   5. Flow of Decoding Process according to Embodiment
5-1. Schematic Flow
5-2. Process Relating to Intra Prediction
5-3. Process Relating to Inter Prediction

### 6. Applications

### 7. Conclusion

### 1. OVERVIEW

### 1-1. Scalable Video Coding

A plurality of layers each including a series of images are encoded in the scalable video coding. Base layers are the first to be encoded, and represent the roughest images. Encoded stream of base layers may be independently decoded without decoding of encoded streams of the other layers. The layers other than base layers are referred to as enhancement layers representing finer images. Encoded streams of enhancement layers are encoded using information included in encoded streams of base layers. Thus, to reproduce an image of an enhancement layer, encoded streams of both base layer and enhancement layer are decoded. Any number of layers greater than or equal to two layers may be handled in the scalable video coding. When three layers or more are encoded, the lowest layer is a base layer and the remaining layers are enhancement layers. Encoded streams of upper enhancement layers may be encoded and decoded using information included in encoded streams of the lower enhancement layers or an encoded stream of the base layer.

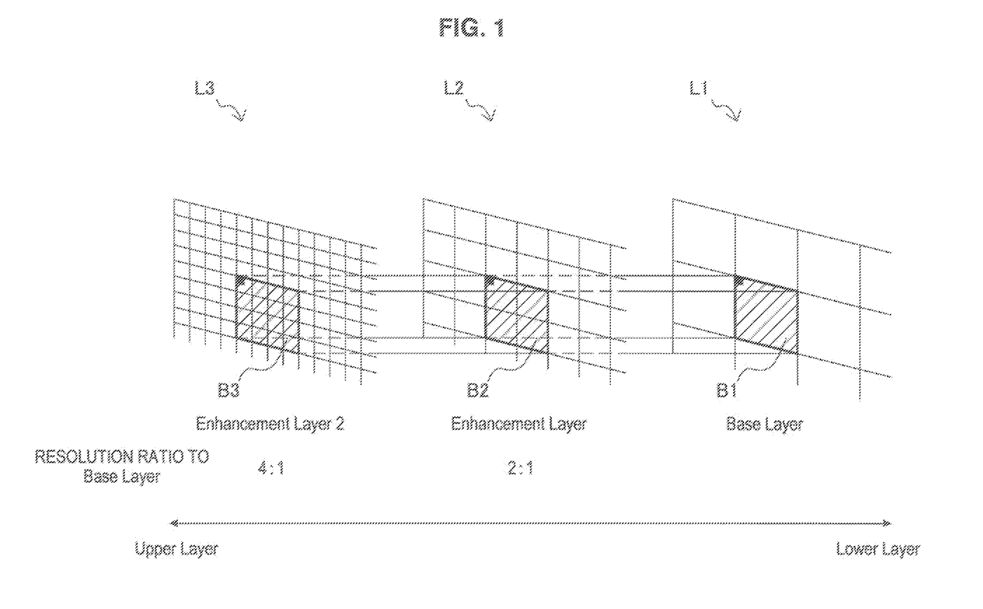

FIG. 1 illustrates three layers L1, L2, and L3 that are subjected to the scalable video coding. The layer L1 is a base layer, while the layers L2 and L3 are enhancement layers. Among various kinds of scalability, spatial scalability is described as an example. The ratio of spatial resolution of the layer L2 to that of the layer L1 stands at 2:1. The ratio of spatial resolution of the layer L3 to that of the layer L1 stands at 4:1. These resolution ratios are merely examples. Non-integer resolution ratios such as 1.5:1 may also be used. A block B1 of the layer L1 is a processing unit for a prediction process in a picture of the base layer. A block B2 of the layer L2 is a processing unit for a prediction process in a picture of the enhancement layer showing a scene common to the block B1. The block B2 corresponds to the block B1 of the layer L1. A block B3 of the layer L3 is a processing unit for a prediction process in a picture of the upper enhancement layer showing a scene common to the blocks B1 and B2. The block B3 corresponds to the block B1 of the layer L1 and the block B2 of the layer L2.

A spatial correlation between images is similar between layers showing common scenes in this layer structure. For example, when the block B1 has a strong correlation with a neighboring block in a given direction in the layer L1, the block B2 is likely to have a strong correlation with a neighboring block in the same direction in the layer L2. In the same way, a temporal correlation between images of a layer is usually similar with a correlation between images of another layer showing common scenes. For example, when the block B1 has a strong correlation with a reference block in a given reference image in the layer L1, the block B2 is likely to have a strong correlation with the corresponding reference block in the same reference image (only the layer is different) in the layer L2. The same applies to the layer L2 and the layer L3. In addition to this spatial correlation and temporal correlation, the dispersion (variation) of pixel values of each block is also a characteristic of images that may be similar between layers. This characteristic of images will be used in an embodiment described below.

Prediction mode information for intra prediction and inter prediction is reused between layers on the basis of the similarity of the image characteristics, which may contribute to the reduction in the amount of codes. However, when different prediction mode sets are supported between layers, the reuse of prediction mode information causes some restrictions and requires complicated mapping of information in most cases. As an example, let us assume in the following description that base layers are encoded in the advanced video coding (AVC) scheme, while enhancement layers are encoded in the HEVC scheme. The technology according to the present disclosure is not limited to the example, but is also applicable to combinations of other image encoding schemes (e.g. base layers are encoded in the MPEG 2 scheme, while enhancement layers are encoded in the HEVC scheme, etc.).

### 1-2. Prediction Mode Set for Base Layer

### (1) Intra Prediction

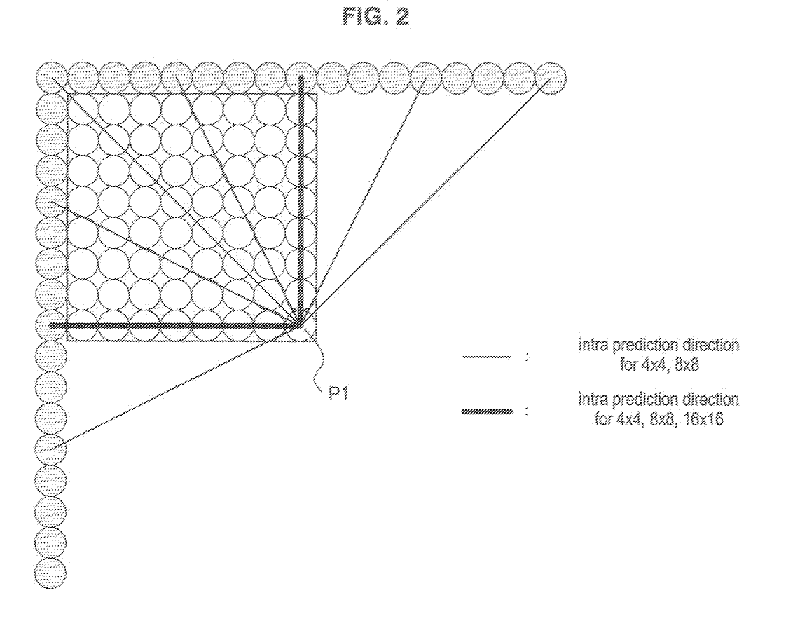

Prediction mode sets for intra prediction in the AVC scheme will be described using FIG. 2.

A plurality of prediction modes associated with various prediction directions may be used in the AVC scheme in addition to DC prediction and planar prediction. The angular resolution in a prediction direction is lower than that of the HEVC scheme.

FIG. 2 illustrates selectable candidate prediction directions in the AVC scheme. A pixel P1 illustrated in FIG. 2 is a prediction target pixel. The shaded pixels around the block to which the pixel P1 belongs are reference pixels. In addition to the DC prediction, (prediction modes corresponding to) eight types of prediction direction are selectable at a block size of 4×4 pixels or 8×8 pixels, the eight types of prediction direction being illustrated in solid lines (both thick lines and thin lines) in the figure and connecting the reference pixels to the prediction target pixel. In addition to the DC prediction and the planar prediction, (prediction modes corresponding to) two types of prediction direction illustrated in thick solid lines in the figure are selectable at a block size of 16×16 pixels.

### (2) Inter Prediction

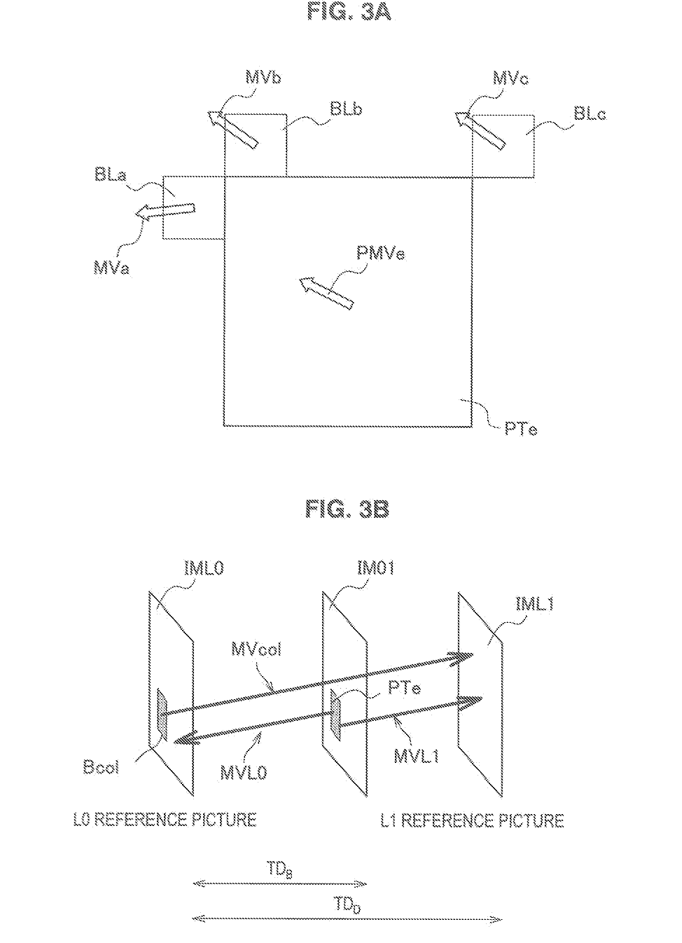

Next, prediction mode sets for inter prediction in the AVC scheme will be described using FIGS. 3A and 3B.

Reference image numbers and motion vectors can be decided for each prediction block having the block size selected from seven sizes of 16×16 pixels, 16×8 pixels, 8×16 pixels. 8×8 pixels, 8×4 pixels, 4×8 pixels, and 4×4 pixels in inter prediction (motion compensation) in the AVC scheme. Motion vectors are then predicted in order to reduce the amount of codes for motion vector information.

FIG. 3A illustrates three neighboring blocks BLa, BLb, and BLc adjacent to a prediction block PTe. Motion vectors set to these neighboring blocks BLa, BLb, and BLc are motion vectors MVa, MVb, and MVc, respectively. A predicted motion vector PMVe of the prediction block PTe may be calculated from the motion vectors MVa, MVb, and MVc using the following prediction expression.

[Math. 1]

PMVe=med(MVa,MVb,MVc) (1)

Med in the expression (1) represents a median operation. That is, according to the expression (1), the predicted motion vector PMVe has the median of horizontal components of the motion vectors MVa. MVb and MVc, and the median of vertical components thereof. When some of the motion vectors MVa, MVb, and MVc does not exist because, for example, the prediction block PTe is positioned at the edge of an image, the non-existent motion vector may be omitted from the arguments of the median operation. Once the predicted motion vector PMVe is decided, a difference motion vector MVDe is further calculated in accordance with the following expression. Additionally, the MVe represents an actual motion vector (optimal motion vector decided as a search result) used for motion compensation for the prediction block PTe.

[Math. 2]

MVDe=MVe−PMVe (2)

Motion vector information and reference image information representing the difference motion vector MVDe calculated in this way may be encoded for each prediction block in the AVC scheme.

The AVC scheme supports a so-called direct mode intended chiefly for B pictures to further reduce the amount of codes for motion vector information. Motion vector information is not encoded in the direct mode, but motion vector information on an encoding target prediction block is generated from the motion vector information on an encoded prediction block. The direct mode has two types of mode: spatial direct mode and temporal direct mode. For example, the motion vector MVe of the prediction block PTe may be decided as shown in the following expression using the expression (1) in the spatial direction mode.

[Math. 3]

MVe=PMVe (3)

FIG. 3B schematically illustrates the concept of the temporal direct mode. FIG. 3B illustrates a reference image IML0 and a reference image IML1, the reference image IML0 being an L0 reference picture of an encoding target image IMO 1, the reference image IML1 being an L1 reference picture of the encoding target image IMO 1. A block Bcol in the reference image IML0 is a collocated block of the prediction block PTe in the encoding target image IM01. A motion vector set to the collocated block Bcol is here an MVcol. The distance between the encoding target image IM01 and the reference image IML0 on the time axis is TDB, while the distance between the reference image IML0 and the reference image IML1 on the time axis is TD_{D}. Motion vectors MVL0 and MVL1 of the prediction block PTe may be decided in the temporal direct mode as shown in the following expression.

$$\begin{matrix}[ Math . 4 ] & \\ MVL 0 = \frac{{TD}_{B}}{{TD}_{D}} MVcol & ( 4 ) \\ MVL 1 = - \frac{{TD}_{D} - {TD}_{B}}{{TD}_{D}} MVcol & ( 5 )\end{matrix}$$

The AVC scheme designates for each slice which of the spatial direct mode and the temporal direct mode is available, and then designates for each prediction block whether the direct mode is used.

### 1-3. Prediction Mode Set for Enhancement Layer

### (1) Intra Prediction

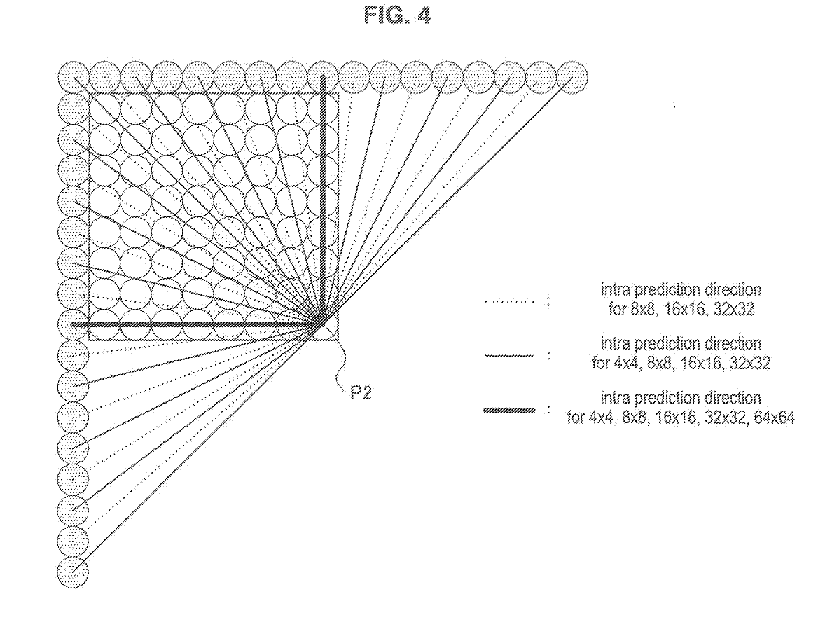

Next, prediction mode sets for intra prediction in the HEVC scheme will be described using FIG. 4.

A plurality of prediction modes associated with various prediction directions may be used in the HEVC scheme in addition to the DC prediction and the planar prediction as in the AVC scheme. Angular prediction in the HEVC scheme, however, has better angular resolution in a prediction direction than that of the AVC scheme.

FIG. 4 illustrates selectable candidate prediction directions in the angular prediction in the HEVC scheme. A pixel P2 illustrated in FIG. 4 is a prediction target pixel. The shaded pixels around the block to which the pixel P2 belongs are reference pixels. In addition to the DC prediction, (prediction modes corresponding to) 17 types of prediction direction are selectable at a block size of 4×4 pixels, the 17 types of prediction direction being illustrated in solid lines (both thick lines and thin lines) in the figure and connecting the reference pixels to the prediction target pixel. In addition to the DC prediction and the planar prediction, (prediction modes corresponding to) 33 types of prediction direction are selectable at a block size of 8×8 pixels, 16×16 pixels, or 32×32 pixels, the 33 types of prediction direction being illustrated in dashed lines and solid lines (both thick lines and thin lines) in the figure. In addition to the DC prediction, (prediction modes corresponding to) two types of prediction direction are selectable at a block size of 64×64 pixels, the two types of prediction direction being illustrated in thick lines in the figure. Furthermore, the HEVC scheme supports a luma-based chroma prediction mode (LM mode) for a prediction unit of chroma components, the luma-based chroma prediction mode being used for generating predicted images of chroma components on the basis of luma components in the same block.

As understood from the description, prediction mode sets supported for the intra prediction in the HEVC scheme are not the same as prediction mode sets supported for the intra prediction in the AVC scheme. For example, the HEVC scheme supports the DC prediction mode and the planar prediction mode for luma components at a given block size, while the AVC scheme does not support the planar prediction mode. Meanwhile, the HEVC scheme supports the LM mode for chroma components, while the AVC scheme does not support the LM mode. It is thus difficult to simply map a prediction mode set in the AVC scheme for base layers into a prediction mode set in the HEVC scheme for enhancement layers.

### (2) Inter Prediction

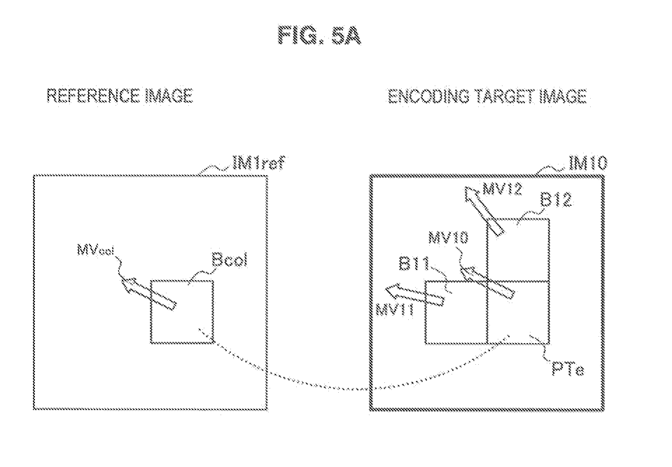

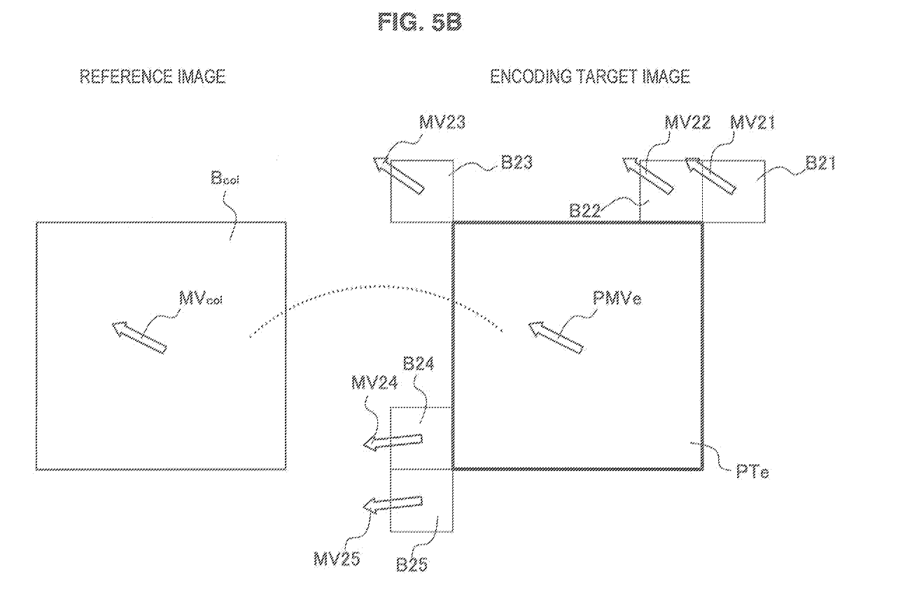

Next, prediction mode sets for inter prediction in the HEVC scheme will be described using FIGS. 5A and 5B.

The HEVC scheme newly supports a merge mode as a prediction mode for inter prediction. The merge mode is a prediction mode that merges a given prediction block with a block having the common motion information among reference blocks in the neighborhood in the spatial direction or the temporal direction to skip encoding of the motion information for the prediction block. The mode merging a prediction block in the spatial direction is referred to as spatial merge mode, while the mode merging a prediction block in the temporal direction is referred to as temporal merge mode.

FIG. 5A, for example, illustrates a prediction block PTe in an encoding target image IM10. Blocks B11 and B12 are neighboring blocks each positioned on the left of and above the prediction block PTe. A motion vector MV10 is calculated for the prediction block PTe. Motion vectors MV11 and MV12 are reference motion vectors calculated for the neighboring blocks B11 and B12, respectively. Furthermore, a collocated block Bcol of the prediction block PTe is illustrated in a reference image IM1ref. A motion vector MVcol is a reference motion vector calculated for the collocated block Bcol.

When the motion vector MV10 is equal to the reference motion vector MV11 or MV12 in the example of FIG. 5A, merge information may be encoded, the merge information indicating that the prediction block PTe is spatially merged. Actually, the merge information may additionally indicate with which neighboring block the prediction block PTe is merged. Meanwhile, when the motion vector MV10 is equal to the reference motion vector MVcol, merge information may be encoded, the merge information indicating that the prediction block PTe is temporally merged. When the prediction block PTe is spatially or temporally merged, motion vector information and reference image information are not encoded for the prediction block PTe.

When the prediction block PTe is not merged with another block, motion vector information is encoded for the prediction block PTe. A mode that encodes motion vector information is referred to as advanced motion vector prediction (AMVP) in the HEVC scheme. The AMVP mode may encode predictor information, difference motion vector information, and reference image information as motion information. Different from the prediction expression in the AVC scheme, a predictor in the AMVP mode includes no median operation.

FIG. 5B, for example, illustrates a prediction block PTe in an encoding target image again. Blocks B21 to B25 are neighboring blocks adjacent to the prediction block PTe. A Block Bcol is a collocated block of a prediction block PTe in a reference image. When a spatial predictor is used, predictor information may indicate any of blocks B21 to B25. When a temporal predictor is used, predictor information indicates the block Bcol. A motion vector of a reference block indicated by the predictor information is then used as a predicted motion vector of the prediction block PTe. A difference motion vector MVDe of the prediction block PTe is calculated with the same calculation expression as the expression (2). The AMVP mode using spatial predictors is referred to as spatial motion vector prediction mode, while the AMVP mode using temporal predictors is referred to as temporal motion vector prediction mode.

As understood from the description, prediction mode sets supported for the inter prediction in the HEVC scheme are not the same as prediction mode sets supported for the inter prediction in the AVC scheme. For example, the direct mode supported in the AVC scheme is not supported in the HEVC scheme. To the contrary, the merge mode supported in the HEVC scheme is not supported in the AVC scheme. Predictors used for predicting motion vectors in the AMVP mode in the HEVC scheme are different from predictors used in the AVC scheme. It is thus difficult to simply map a prediction mode set in the AVC scheme for base layers into a prediction mode set in the HEVC scheme for enhancement layers.

### 1-4. BLR Mode

Non-Patent Literature 2 assumes that it is difficult to map parameters between layers in the scalable video coding in some cases, and proposes a BLR mode that reuses only reconstructed images of base layers in enhancement layers. Reconstructed images are reconstructed by decoding encoded streams generated through processes such as prediction encoding, orthogonal transform, and quantization. Reconstructed images are used in encoders as reference images for prediction encoding, the reconstructed images being generated by local decoders. Reconstructed images are not only used as reference images in decoders, but may also be final output images for display, editing, or the like. Image encoding schemes including prediction encoding such as the MPEG2 scheme, the AVC scheme, and the HEVC scheme generally generate reconstructed images regardless of what prediction mode set is supported. Difference in image encoding schemes thus has no influence on the BLR mode, which reuses only reconstructed images.

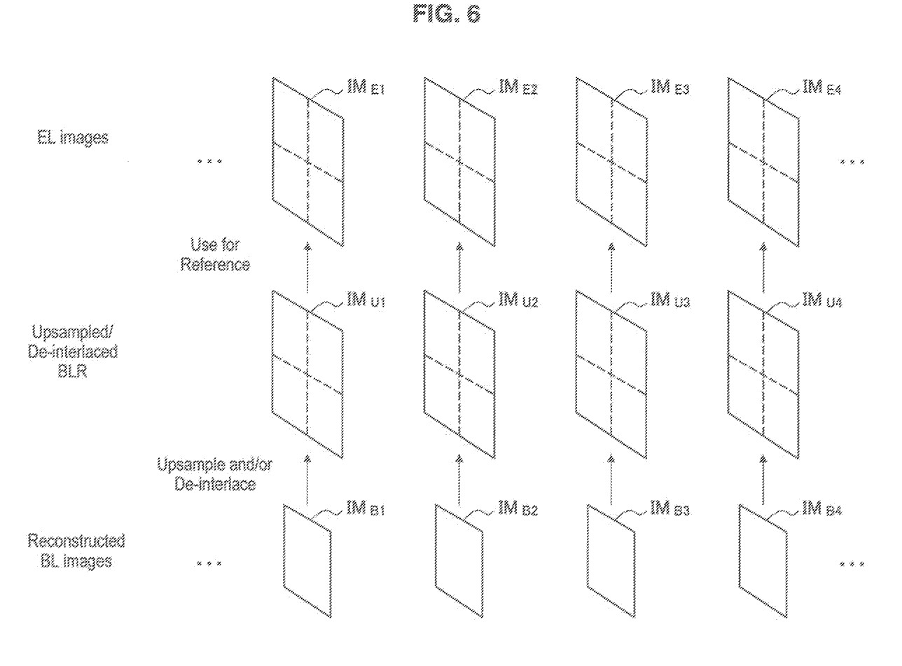

FIG. 6 is an explanatory diagram for describing the scalable video coding in the BLR mode. The bottom of FIG. 6 illustrates reconstructed images IM_{B1} to IM_{B4} of a base layer (BL). According to Non-Patent Literature 2, these reconstructed images are de-interlaced and/or upsampled as needed. The middle of FIG. 6 illustrates de-interlaced and upsampled reconstructed images IM_{U1} to IM_{U4}. Referencing the reconstructed images IM_{U1} to IM_{U4} encodes and decodes images IM_{E1} to IM_{E4} of an enhancement layer (EL) illustrated in the top of FIG. 6. Parameters of the base layer other than ones derived from the reconstructed images are not then reused.

The BLR mode strengthens the independence of each layer in this way. The independence, however, requires a large number of parameters to be encoded in enhancement layers. As a result, sufficient encoding efficiency is not sometimes achieved in enhancement layers. The way of reusing reconstructed images in the BLR mode are improved in an embodiment described in detail in the next and subsequent sections, so that the amount of codes for enhancement layers are reduced and better encoding efficiency is achieved.

### 1-5. Example of Basic Configuration of Encoder

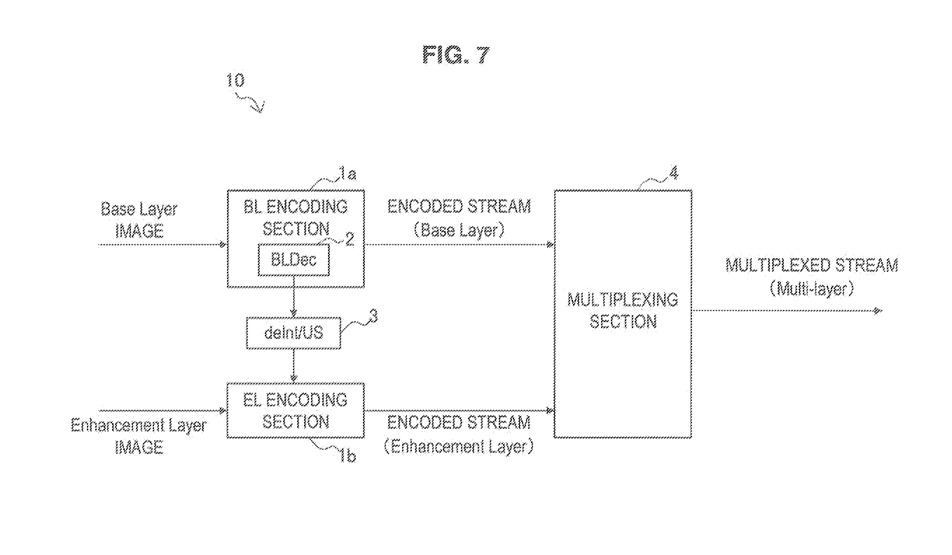

FIG. 7 is a block diagram illustrating a schematic configuration of an image encoding device 10 according to an embodiment, the image encoding device 10 supporting the scalable video coding in the BLR mode. FIG. 7 illustrates that the image encoding device 10 includes a BL encoding section 1a, an EL encoding section 1b, an intermediate processing section 3, and multiplexing section 4.

The BL encoding section 1a encodes a base layer image, and generates an encoded stream of a base layer. The BL encoding section 1a includes a local decoder 2. The local decoder 2 generates a reconstructed image of the base layer. The intermediate processing section 3 may function as a de-interlace section or an upsampling section. When the reconstructed image of the base layer, which is input from the BL encoding section 1a, is interlaced, the intermediate processing section 3 de-interlaces the reconstructed image. The intermediate processing section 3 also upsamples reconstructed images in accordance with the spatial resolution ratio between the base layer and an enhancement layer. The process by the intermediate processing section 3 may be omitted. The EL encoding section 1b encodes an enhancement layer image, and generates an encoded stream of an enhancement layer. As described below in detail, the EL encoding section 1b reuse a reconstructed image of the base layer in encoding the enhancement layer image. The multiplexing section 4 multiplexes the encoded stream of the base layer generated by the BL encoding section 1a, and the encoded stream of the enhancement layer generated by the EL encoding section 1b, and generates a multiplexed stream of a multi-layer.

### 1-6. Example of Basic Configuration of Decoder

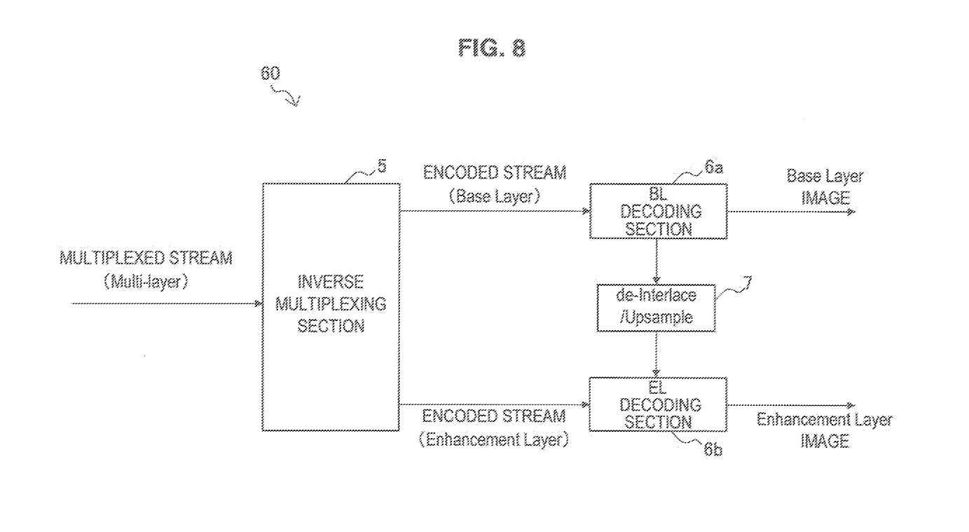

FIG. 8 is a block diagram illustrating a schematic configuration of an image decoding device 60 according to an embodiment, the image decoding device 60 supporting the scalable video coding in the BLR mode. FIG. 8 illustrates that the image decoding device 60 includes an inverse multiplexing section 5, a BL decoding section 6a, an EL decoding section 6b, and an intermediate processing section 7.

The inverse multiplexing section 5 inversely multiplexes a multiplexed stream of a multi-layer to obtain an encoded stream of a base layer and an encoded stream of an enhancement layer. The BL decoding section 6a decodes the encoded stream of the base layer to obtain a base layer image. The intermediate processing section 7 may function as a de-interlace section or an upsampling section. When a reconstructed image of the base layer which is input from the BL decoding section 6a has been interlaced, the intermediate processing section 7 de-interlaces the reconstructed image. The intermediate processing section 7 also upsamples a reconstructed image in accordance with the ratio of the spatial resolution between the base layer and an enhancement layer. The process by the intermediate processing section 7 may be omitted. The EL decoding section 6b decodes an encoded stream of the enhancement layer to obtain an enhancement layer image. As described below in detail, the EL decoding section 6b reuses the reconstructed image of the base layer in decoding the enhancement layer image.

### 2. EXAMPLE OF CONFIGURATION OF EL ENCODING SECTION ACCORDING TO EMBODIMENT

### 2-1. Overall Configuration

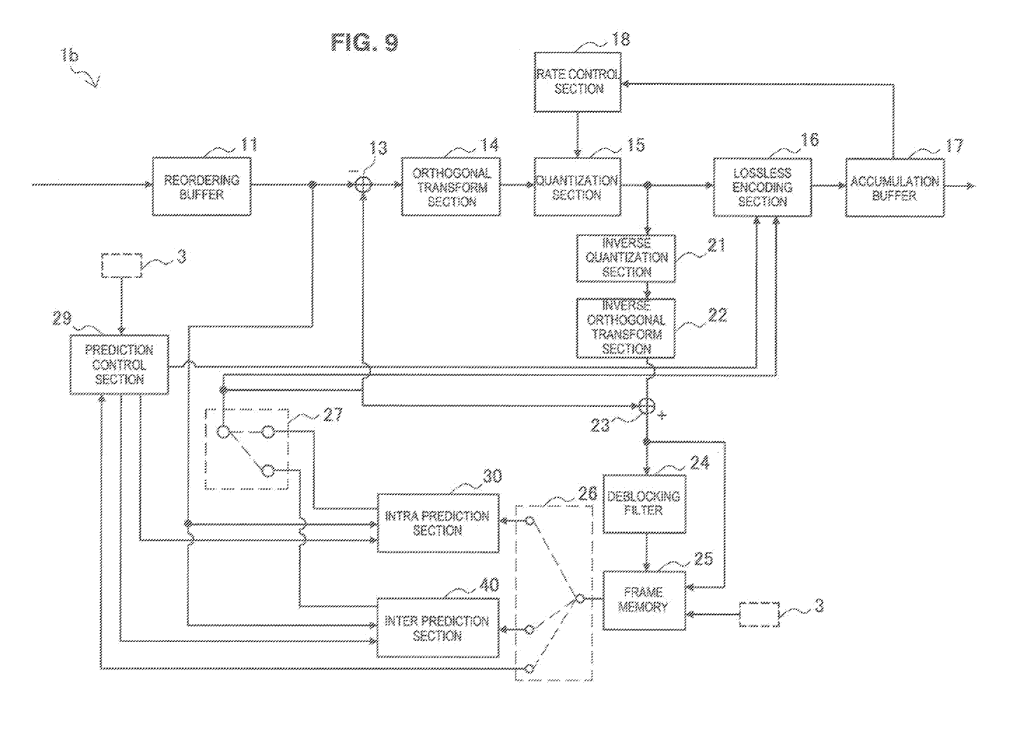

FIG. 9 is a block diagram illustrating an example of the configuration of the EL encoding section 1b illustrated in FIG. 7. FIG. 9 illustrates that the EL encoding section 1b includes a reordering buffer 11, a subtraction section 13, an orthogonal transform section 14, a quantization section 15, a lossless encoding section 16, an accumulation buffer 17, a rate control section 18, an inverse quantization section 21, an inverse orthogonal transform section 22, an addition section 23, a deblocking filter 24, a frame memory 25, selectors 26 and 27, a prediction control section 29, an intra prediction section 30, and an inter prediction section 40.

The reordering buffer 11 reorders images included in a series of image data. The reordering buffer 11 reorders images in accordance with a GOP (group of pictures) structure for an encoding process, and then outputs the reordered image data to the subtraction section 13, the intra prediction section 30, and the inter prediction section 40.

The subtraction section 13 is supplied with the image data input from the reordering buffer 11, and predicted image data that will be described below and has been input from the intra prediction section 30 or the inter prediction section 40. The subtraction section 13 calculates predicted error data that is a difference between the image data input from the reordering buffer 11 and the predicted image data, and outputs the calculated predicted error data to the orthogonal transform section 14.

The orthogonal transform section 14 performs orthogonal transform on the predicted error data input from the subtraction section 13. The orthogonal transform to be performed by the orthogonal transform section 14 may be discrete cosine transform (DCT) or Karhunen-Loeve transform, for example. The orthogonal transform section 14 outputs transform coefficient data acquired through the orthogonal transform process to the quantization section 15.

The transform coefficient data input from the orthogonal transform section 14 and a rate control signal from the rate control section 18 described below are supplied to the quantization section 15. The quantization section 15 quantizes the transform coefficient data, and outputs the quantized transform coefficient data (which will be referred to as quantized data, hereinafter) to the lossless encoding section 16 and the inverse quantization section 21. The quantization section 15 switches quantization parameters (quantization scales) on the basis of the rate control signal from the rate control section 18 to change the bit rate of the quantized data.

The lossless encoding section 16 performs a lossless encoding process on the quantized data input from the quantization section 15 to generate an encoded stream of an enhancement layer. The lossless encoding section 16 also encodes information on intra prediction or information on inter prediction input from the selector 27, and multiplexes an encoding parameter into the header region of the encoded stream. As described below, the information on inter prediction may include an additional parameter such as a parameter indicating a prediction block size during motion vector search for a reconstructed image, and a parameter indicating the searched spatial range. The lossless encoding section 16 then outputs the generated encoded stream to the accumulation buffer 17.

The lossless encoding section 16 may generate encoded streams in accordance with a context-based encoding scheme such as context-based adaptive binary arithmetic coding (CABAC). In that case, the lossless encoding section 16 may, for example, generate an encoded stream of an enhancement layer while switching contexts in accordance with the spatial characteristics of a reconstructed image. The spatial characteristics of the reconstructed image may be computed by the prediction control section 29, which will be described below.

The accumulation buffer 17 uses a storage medium such as semiconductor memory to temporarily store the encoded stream input from the lossless encoding section 16. The accumulation buffer 17 then outputs the accumulated encoded stream to a transmission section that is not illustrated (e.g. communication interface or connection interface for a peripheral device, etc.), at the rate according to the bandwidth of a transmission channel.

The rate control section 18 monitors the free space of the accumulation buffer 17. The rate control section 18 generates a rate control signal in accordance with the free space of the accumulation buffer 17, and then outputs the generated rate control signal to the quantization section 15. For example, when the accumulation buffer 17 has little free space, the rate control section 18 generates a rate control signal for lowering the bit rate of the quantized data. For example, when the accumulation buffer 17 has sufficient free space, the rate control section 18 generates a rate control signal for increasing the bit rate of the quantized data.

A local decoder includes the inverse quantization section 21, the inverse orthogonal transform section 22, and the addition section 23. The inverse quantization section 21 performs an inverse quantization process on the quantized data input from the quantization section 15. The inverse quantization section 21 the outputs transform coefficient data acquired through the inverse quantization process to the inverse orthogonal transform section 22.

The inverse orthogonal transform section 22 performs an inverse orthogonal transform process on the transform coefficient data input from the inverse quantization section 21 to thereby restore the predicted error data. The inverse orthogonal transform section 22 then outputs the restored predicted error data to the addition section 23.

The addition section 23 adds the restored predicted error data input from the inverse orthogonal transform section 22 to the predicted image data input from the intra prediction section 30 or the inter prediction section 40 to generate the decoded image data (reconstructed image of the enhancement layer). The addition section 23 then outputs the generated decoded image data to the deblocking filter 24 and the frame memory 25.

The deblocking filter 24 performs a filtering process for reducing blocking artifacts produced at the time of image encoding. The deblocking filter 24 removes blocking artifacts by filtering the decoded image data input from the addition section 23, and outputs the filtered decoded image data to the frame memory 25.

The frame memory 25 uses a storage medium to store the decoded image data input from the addition section 23, the filtered decoded image data input from the deblocking filter 24, and the reconstructed image data of the base layer input from the intermediate processing section 3.

The selector 26 reads out, from the frame memory 25, the decoded image data that has not yet been filtered and is to be used for intra prediction, and supplies the read-out decoded image data to the intra prediction section 30 as reference image data. The selector 26 also reads out, from the frame memory 25, the filtered decoded image data to be used for inter prediction, and supplies the read-out decoded image data to the inter prediction section 40 as reference image data. The selector 26 outputs the reconstructed image data of the base layer to the prediction control section 29.

The selector 27 outputs, to the subtraction section 13, the predicted image data that is a result of intra prediction output from the intra prediction section 30, and outputs information on intra prediction to the lossless encoding section 16 in the intra prediction mode. The selector 27 also outputs, to the subtraction section 13, the predicted image data that is a result of inter prediction output from the inter prediction section 40, and outputs information on inter prediction to the lossless encoding section 16 in the inter prediction mode. The selector 27 switches the intra prediction mode and the inter prediction mode in accordance with the magnitude of a cost function value.

The prediction control section 29 uses a reconstructed image of the base layer generated by the local decoder 2 in the BL encoding section 1a, and controls a prediction mode that is selected when the intra prediction section 30 and the inter prediction section 40 generate a predicted image of the enhancement layer. The detailed control exerted by the prediction control section 29 will be described below more specifically. The prediction control section 29 may compute the spatial characteristics of the reconstructed image of the base layer, and may allow the lossless encoding section 16 to switch contexts for a lossless encoding process in accordance with the computed spatial characteristics.

The intra prediction section 30 performs an intra prediction process in prediction units (PUs) in the HEVC scheme on the basis of the original image data and the decoded image data of the enhancement layer. For example, the intra prediction section 30 uses a predetermined cost function to evaluate a prediction result in each candidate mode in a prediction mode set controlled by the prediction control section 29. Next, the intra prediction section 30 selects a prediction mode yielding the smallest cost function value which namely means a prediction mode yielding the highest compression ratio as the optimal prediction mode. The intra prediction section 30 also generates predicted image data of the enhancement layer in accordance with the optimal prediction mode. The intra prediction section 30 then outputs information on intra prediction, the cost function value, and the predicted image data to the to the selector 27, the information including prediction mode information indicating the selected optimal prediction mode.

The inter prediction section 40 performs an inter prediction process in prediction units in the HEVC scheme on the basis of the original image data and the decoded image data of the enhancement layer. For example, the inter prediction section 40 uses a predetermined cost function to evaluate a prediction result in each candidate mode in a prediction mode set controlled by the prediction control section 29. Next, the inter prediction section 40 selects a prediction mode yielding the smallest cost function value which namely means a prediction mode yielding the highest compression ratio as the optimal prediction mode. The inter prediction section 40 also generates predicted image data of the enhancement layer in accordance with the optimal prediction mode. The inter prediction section 40 then outputs information on inter prediction, the cost function value, and the predicted image data to the selector 27, the information including prediction mode information indicating the selected optimal prediction mode, and motion information.

### 2-2. Specific Configuration Relating to Intra Prediction

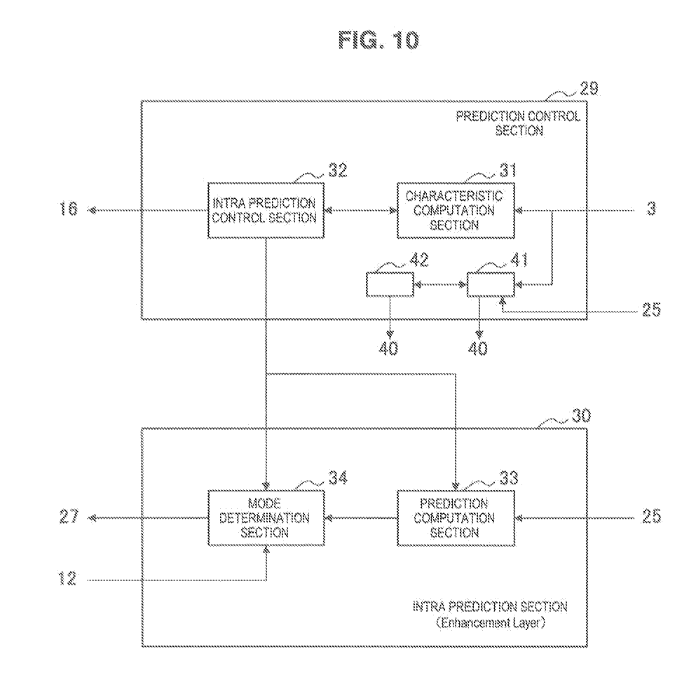

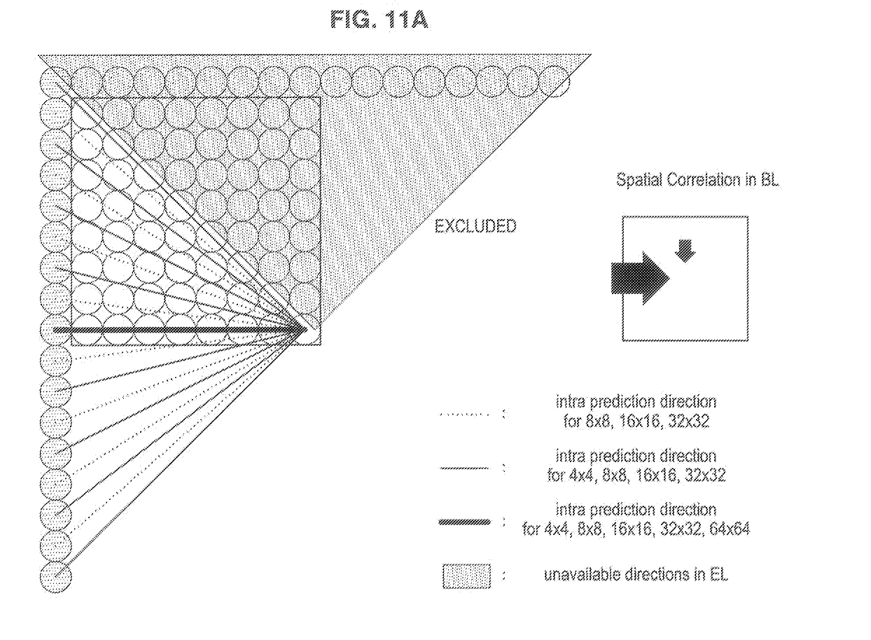

FIG. 10 is a block diagram illustrating an example of the specific configurations of the prediction control section 29 and the intra prediction section 30 illustrated in FIG. 9. FIG. 10 illustrates that the prediction control section 29 includes a characteristic computation section 31, an intra prediction control section 32, a search section 41, and an inter prediction control section 42. The intra prediction section 30 includes a prediction control section 33 and a mode determination section 34.

The characteristic computation section 31 computes the spatial characteristics of a reconstructed image of a base layer input from the intermediate processing section 3 by using the reconstructed image. The spatial characteristics computed by the characteristic computation section 31 may include at least one of the spatial correlation and dispersion of pixel values. As an example, the characteristic computation section 31 computes the horizontal correlation C_{H} and the vertical correlation C_{V} for each prediction block in accordance with the following expressions (6) and (7).

$$\begin{matrix}[ Math . 5 ] & \\ {C}_{H} = \frac{{\sum }_{i = 0}^{I - 1} {\sum }_{j = 0}^{J - 1} \vert {A}_{i + 1 , j} - {A}_{i , j} \vert}{I \cdot J} & ( 6 ) \\ {C}_{V} = \frac{{\sum }_{i = 0}^{I - 1} {\sum }_{j = 0}^{J - 1} \vert {A}_{i , j + 1} - {A}_{i , j} \vert}{I \cdot J} & ( 7 )\end{matrix}$$

It is noted that i and j represent horizontal and vertical indexes at a pixel position in a prediction block, A_{i,j} represents a pixel value at a pixel position (i, j), I represents the number of pixels in the horizontal direction in the prediction block, and J represents the number of pixels in the vertical direction in the prediction block in the expressions (6) and (7). The horizontal correlation C_{H} computed in this way has a higher value with a greater difference from the horizontally neighboring pixel. A lower value of the horizontal correlation C_{H} thus means a stronger horizontal correlation in a prediction block. In the same way, a lower value of the vertical correlation C_{V} means a stronger vertical correlation in a prediction block.

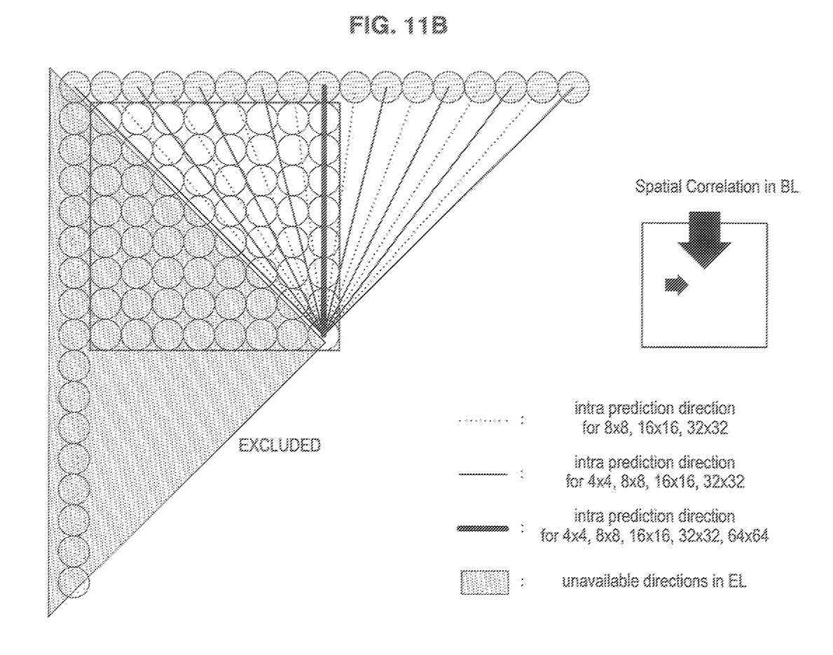

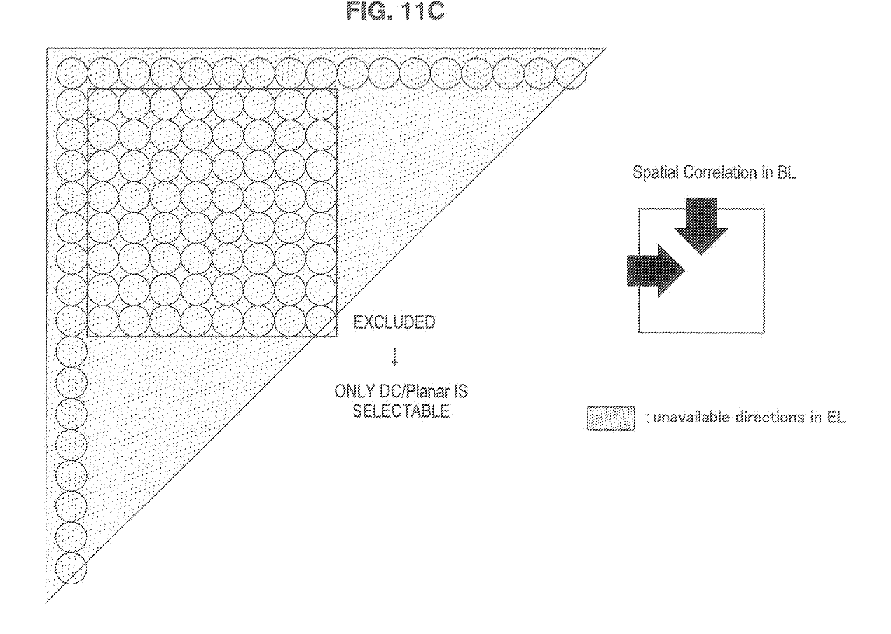

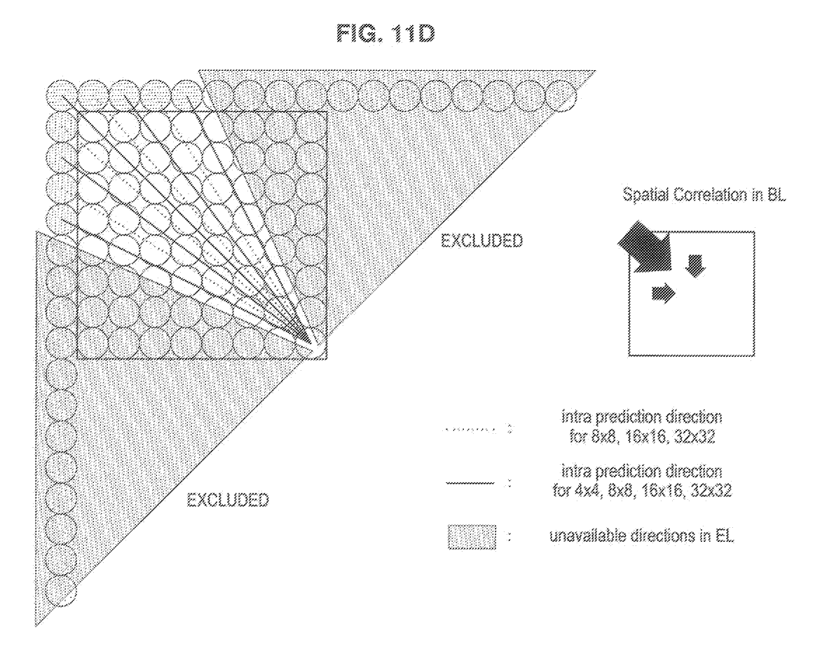

The intra prediction control section 32 controls prediction modes for intra prediction executed by the intra prediction section 30 on the basis of the spatial characteristics computed by the characteristic computation section 31. More specifically, the intra prediction control section 32 may narrow down selectable candidate modes on the basis of the spatial characteristics such that the candidate modes include a prediction mode relating to a computation result of the spatial characteristics input from the characteristic computation section 31. FIGS. 11A to 11D illustrates four specific examples in which candidate modes are narrowed down on the basis of the spatial characteristics.

For example, when the following determination expression (8) is satisfied for a prediction block, the intra prediction control section 32 determines that a strong horizontal correlation is observed as a spatial characteristic. Th₁ represents a predefined determination threshold. Th₁ may be zero.

[Math. 6]

C_{H}+Th₁<C_{V} (8)

When the determination expression (8) is satisfied, the intra prediction control section 32 excludes prediction modes other than a prediction mode relating to the strong horizontal correlation from the selectable candidate modes. The example of FIG. 11A illustrates that only a prediction mode supporting a prediction direction closer to the horizontal direction in the angular prediction in the HEVC scheme remains in the prediction mode set, and the other prediction modes are excluded from the selectable candidate modes.

When the following expression (9) is satisfied for a prediction block, the intra prediction control section 32 similarly determines that a strong vertical correlation is observed as a spatial characteristic. Th₂ represents a predefined determination threshold. Th₂ may be zero.

[Math. 7]

C_{V}+Th₂<C_{H} (9)

When the determination expression (9) is satisfied, the intra prediction control section 32 excludes prediction modes other than a prediction mode relating to the strong vertical correlation from the selectable candidate modes. The example of FIG. 11B illustrates that only a prediction mode supporting a prediction direction closer to the vertical direction in the angular prediction in the HEVC scheme remains in the prediction mode set, and the other prediction modes are excluded from the selectable candidate modes.

For example, when the following determination expression (10) is satisfied for a prediction mode, the intra prediction control section 32 determines that a strong horizontal and vertical correlation are observed as spatial characteristics, so that the image is flat. Th₃ represents a predefined determination threshold.

[Math. 8]

C_{H}<Th₃ and C_{V}<Th₃ (10)

When the determination expression (10) is satisfied, the intra prediction control section 32 excludes a prediction mode supporting all the prediction directions from the selectable candidate modes. The example of FIG. 11C illustrates that a prediction mode supporting all the prediction directions in the angular prediction in the HEVC scheme is excluded from the prediction mode set, and only the DC prediction and the planar prediction remain as selectable candidate modes.

The spatial characteristics and the determination expressions used by the intra prediction control section 32 are not limited to the examples. The characteristic computation section 31 may, for example, compute the spatial correlation in an upper-left oblique direction of 45 degrees. When the computed spatial correlation shows a strong correlation in the oblique direction, the intra prediction control section 32 may then exclude prediction modes other than a prediction mode relating to the strong correlation in the oblique direction from the selectable candidate modes. The example of FIG. 11D illustrates that only a prediction mode supporting a prediction direction closer to an upper-left oblique direction of 45 degrees in the angular prediction in the HEVC scheme remains in the prediction mode set, and the other prediction modes are excluded from the selectable candidate modes.

Narrowing down candidate modes in this way can decrease the number of candidate modes in the prediction mode set, and reduce the amount of codes for prediction mode information that is encoded in an enhancement layer.

The intra prediction control section 32 may set the mode numbers of prediction modes instead of narrowing down the candidate modes such that a prediction mode strongly relating to a computation result of the spatial characteristics has a low number. For example, when the determination expression (8) is satisfied, the intra prediction control section 32 sets a smaller value to the mode number of a prediction mode supporting a prediction direction closer to the horizontal direction. Meanwhile, when the determination expression (9) is satisfied, the intra prediction control section 32 sets a smaller value to the mode number of a prediction mode supporting a prediction direction closer to the vertical direction. The intra prediction control section 32 may switch tables to be used among a plurality of predefined mapping tables (tables for mapping prediction modes and the mode numbers) in accordance with the spatial characteristics to change the setting of the mode numbers. This adaptive setting of mode numbers allows for a reduction in the amount of codes for prediction mode information resulted from variable-length encoding.

The intra prediction control section 32 may outputs, to the lossless encoding section 16, context information decided as a computation result of the spatial characteristics by the characteristic computation section 31 or decided in accordance with a computation result. In this case, the lossless encoding section 16 can generate an encoded stream in a context-based encoding scheme while switching contexts in accordance with the spatial characteristics of a reconstructed image. This may further develop the encoding efficiency of enhancement layers.

Once the intra prediction control section 32 decides a prediction mode set, the prediction computation section 32 uses the reference image data input from the frame memory 25 to generate a predicted image in prediction units in accordance with one or more prediction modes (candidate modes) in the prediction mode set. The prediction computation section 33 then outputs the generated predicted image to the mode determination section 34. The mode determination section 34 calculates a cost function value of each prediction mode on the basis of the original image data and the predicted image data. When there are a plurality of candidate modes, the mode determination section 34 selects the optimal prediction mode on the basis of the calculated cost function value. The mode determination section 34 then outputs, to the selector 27, the cost function value, the predicted image data, and information on intra prediction which may include prediction mode information indicating the selected optimal prediction mode.

### 2-3. Specific Configuration Relating to Inter Prediction

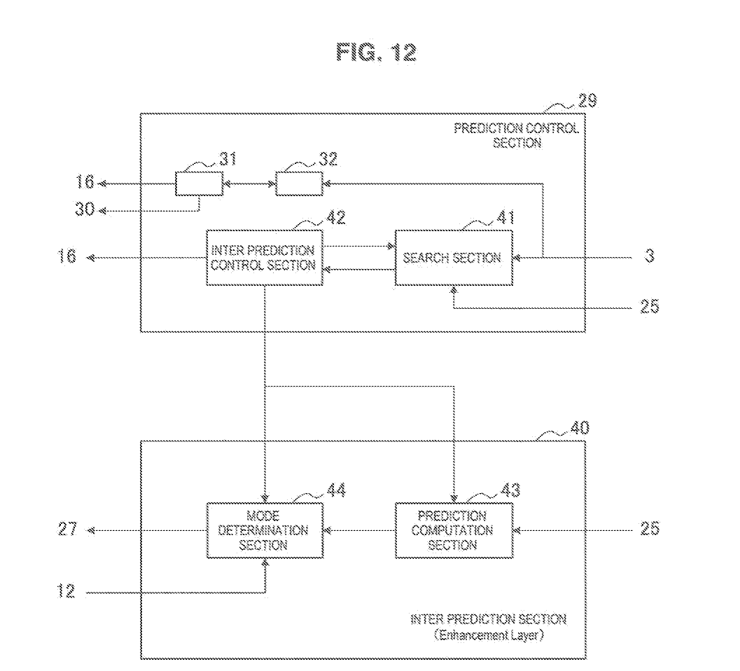

FIG. 12 is a block diagram illustrating an example of the specific configurations of the prediction control section 29 and the inter prediction section 40 illustrated in FIG. 9. FIG. 12 illustrates that the inter prediction section 40 includes a prediction computation section 43, and a mode determination section 44.

The search section 41 searches for a motion vector by using a reconstructed image of a base layer and a reference image input from the intermediate processing section 3 to decide a motion vector optimal for compensating for the motion of a prediction block in the reconstructed image of the base layer. The reference image here means a reconstructed image preceding the reconstructed image of the base layer corresponding to an encoding target image in the encoding order. The reference image may also be a short term reference picture or a long term reference picture. The search section 41 may search for a motion vector by using any know technique such as the block-matching algorithm and the gradient algorithm. Some of television receivers and other image reproducers that are commercially available today are each equipped with an image processing engine (processor) that searches for a motion vector through a post process for achieving a high frame rate. The search section 41 may be implemented using such an image processing engine.

In the present embodiment, the inter prediction control section 42 includes a new prediction mode for inter prediction in the candidate modes that are selectable when the inter prediction section 40 generates a predicted image of an enhancement layer. The new prediction mode here uses a motion vector decided by the search section 41 using the reconstructed image of the base layer. This new prediction mode is herein referred to as BL search mode. The inter prediction control section 42 may add the BL search mode to the prediction mode set as a candidate mode different from the merge mode and the AMVP mode. The addition of the new BL search mode can enhance the prediction accuracy of the inter prediction, the new BL search mode using the image characteristic similarity between layers. Instead, the inter prediction control section 42 may replace the BL search mode with another prediction mode (e.g. temporal merge mode or temporal AMVP mode based on the temporal correlation between motion vectors) in the prediction mode set. In this case, the number of candidate modes in the prediction mode set does not increase, which can prevent the amount of codes needed for prediction mode information from increasing. Additionally, when reference images are different between a current PU and a neighboring PU, a spatial predictor for the neighboring PU is unavailable in the specification of the HEVC scheme described in Non-Patent Literature 1. The inter prediction control section 42 may then replace this unavailable predictor with the BL search mode.

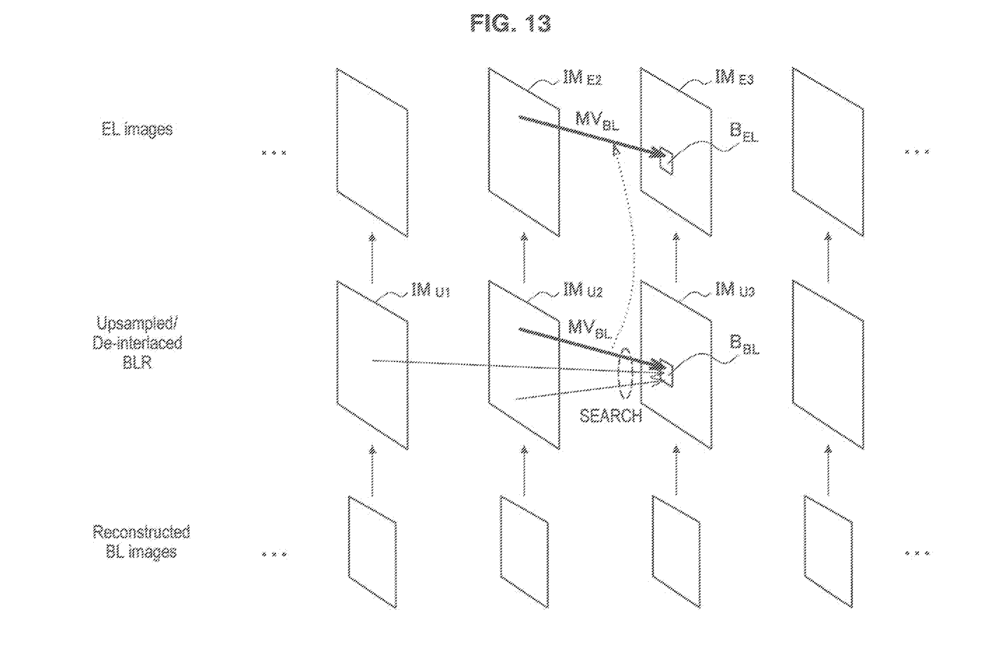

FIG. 13 is an explanatory diagram for describing the BL search mode. An image IM_{E3} in the top of the example of FIG. 13 is an encoding target image of an enhancement layer. A block B_{EL} is a prediction unit in the encoding target image IM_{E3}. An image IM_{U3} is a reconstructed image of a base layer corresponding to the encoding target image IM_{E3}. The block B_{BL} is a prediction block corresponding to a prediction unit B_{EL} in a reconstructed image IM_{B3}. Images IM_{U1} and IM_{U2} are reconstructed images of the base layer, and are used as reference images corresponding to the reconstructed image IM_{U3}. When the prediction unit B_{EL} is an encoding target block, the search section 41 searches for a motion vector optimal for compensating for the motion observed in the prediction block B_{BL} for the reference images IM_{U1} and IM_{U2}. The example of FIG. 13 illustrates that a motion vector MV_{BL} from the reference image IM_{U2} is decided as the optimal motion vector. The inter prediction control section 42 then adopts the motion vector MV_{BL} as a motion vector in the BL search mode for compensating for the motion of the prediction unit B_{EL} in the encoding target image IM_{E3}. In this case, an image IM_{E2} of the enhancement layer is decided as a reference image for the motion vector MV_{BL}. Additionally, the BL search mode does not necessarily have to encode motion information (motion vector information and reference image information) in the same way as the existing merge mode. Instead, the BL search mode may encode difference motion vector information in the same way as the existing AMVP mode.

The prediction computation section 43 uses the reference image data input from the frame memory 25 to generate a predicted image in prediction units in accordance with one or more prediction modes (candidate modes) in the prediction mode set for inter prediction. The prediction computation section 43 uses a motion vector input from the inter prediction control section 42 in the BL search mode. The prediction computation section 43 uses a motion vector that is searched for with the decoded image data of the enhancement layer in the other prediction modes. The prediction computation section 43 then outputs the generated predicted image to the mode determination section 44. The mode determination section 44 calculates a cost function value of each prediction mode on the basis of the original image data and the predicted image data. When there are a plurality of candidate modes, the mode determination section 44 selects the optimal prediction mode on the basis of the calculated cost function value. The mode determination section 44 outputs information on inter prediction, the cost function value, and the predicted image data to the selector 27. The information on inter prediction may include an additional parameter described below in addition to prediction mode information and motion information, the prediction mode information indicating the optimal prediction mode selected by the mode determination section 44.

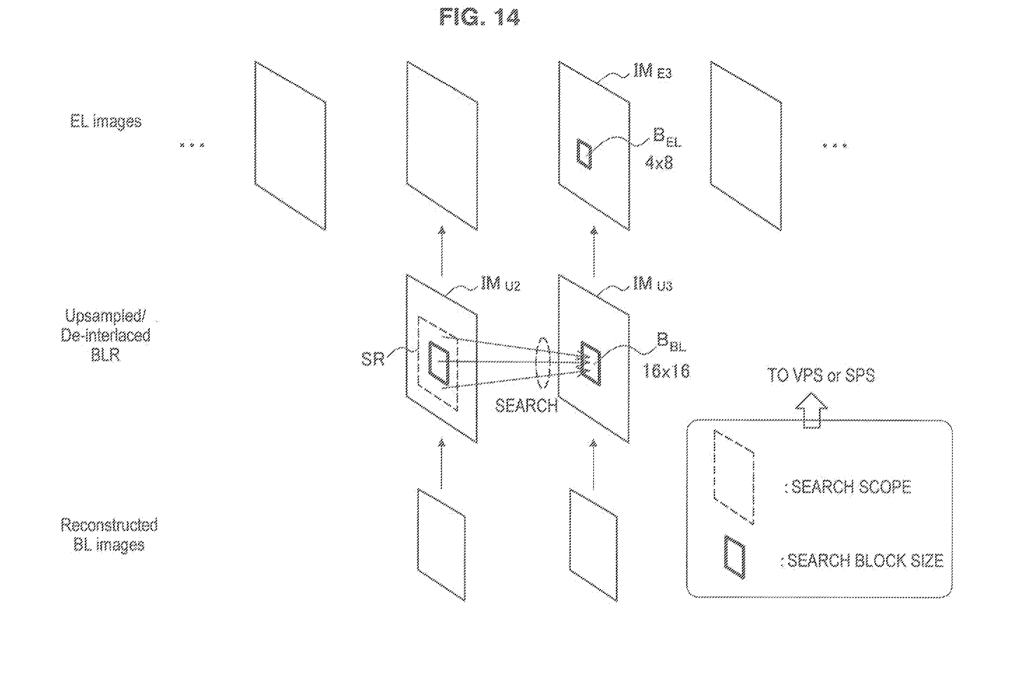

FIG. 14 is an explanatory diagram for describing an encoding parameter relating to motion vector search with a reconstructed image of a base layer. FIG. 14 illustrates again the encoding target image IM_{E3}, the reconstructed image IM_{U3}, and the reference image IM_{U2} illustrated in FIG. 13. The smallest size of prediction units to which inter prediction is applied is 4×8 pixels or 8×4 pixels in the HEVC scheme. The example of FIG. 13 illustrates that the size of a prediction unit B_{EL} in the encoding target image IM_{E3} is 4×8 pixels. Meanwhile, the size of a prediction block B_{BL} in the reconstructed image IM_{E3} may be larger (e.g. 16×16 pixels). That is, the smallest size of a prediction block of a reconstructed image in the BL search mode may be larger than the smallest size of prediction units for inter prediction for an enhancement layer. This can save memory resources by lowering the resolution of the frame memory that stores a series of reconstructed images. The search scope of a motion vector is not the whole reference image, but may be limited to a part of a reference image in the BL search mode. The example of FIG. 13 illustrates that a search scope SR in the reference image IM_{U2} corresponding to the prediction block B_{BL} is a part of the reference image IM_{U2}. This can shorten the processing time needed for a search process in the BL search mode.

An encoder may set the size and search scope of a prediction block in the BL search mode in advance in accordance with the needs of users. The inter prediction control section 42 may output, to the lossless encoding section 16, a parameter indicating the prediction block size or a parameter indicating the search scope, and encode these parameters in a parameter set (e.g. video parameter set (VPS) or sequence parameter set (SPS)) of an encoded stream.

### 3. FLOW OF ENCODING PROCESS ACCORDING TO EMBODIMENT

### 3-1. Schematic Flow

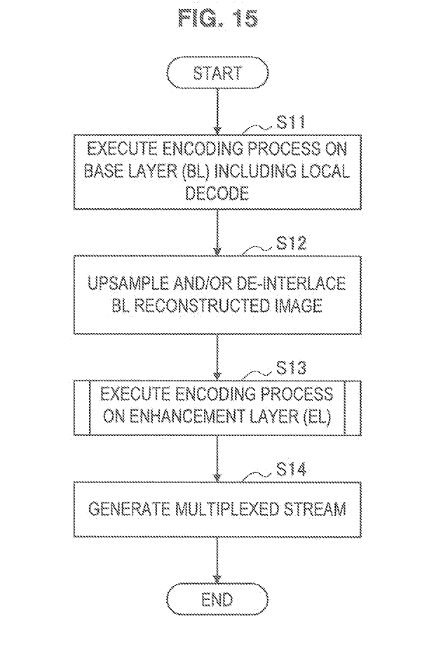

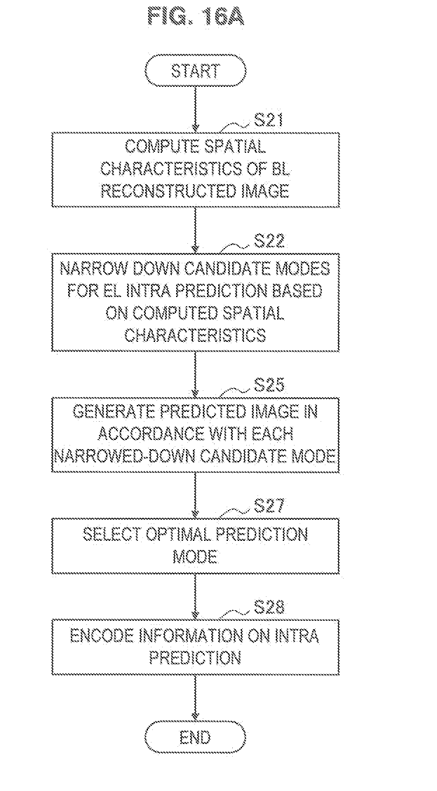

FIG. 15 is a flowchart illustrating an example of a schematic flow of an encoding process according to an embodiment. The description of process steps not directly relating to the technology of the present disclosure is omitted in the drawings for brevity.

FIG. 15 illustrates that, first of all, the BL encoding section 1a executes an encoding process on a base layer, and generates an encoded stream of the base layer (step S11). The local decoder 2 decodes the encoded stream in the encoding process executed here, and generates a reconstructed image of the base layer.

Next, when the reconstructed image of the base layer input from the BL encoding section 1a has been interlaced, the intermediate processing section 3 de-interlaces the reconstructed image. The intermediate processing section 3 upsamples the reconstructed image as needed (step S12).

Next, the EL encoding section 1b uses the reconstructed image processed by the intermediate processing section 3 to execute an encoding process on an enhancement layer, and generates an encoded stream of the enhancement layer (step S13).

Next, the multiplexing section 4 multiplexes the encoded stream of the base layer generated by the BL encoding section 1a and the encoded stream of the enhancement layer generated by the EL encoding section 1b to generate a multiplexed stream of a multi-layer (step S14).

### 3-2. Process Relating to Intra Prediction

### (1) First Example

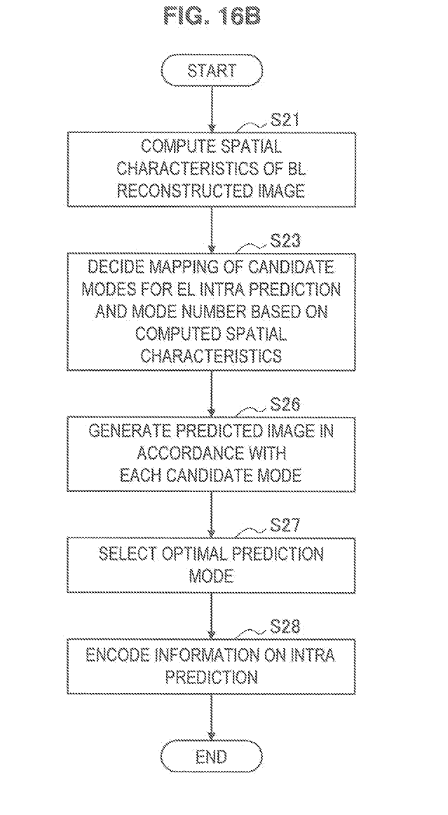

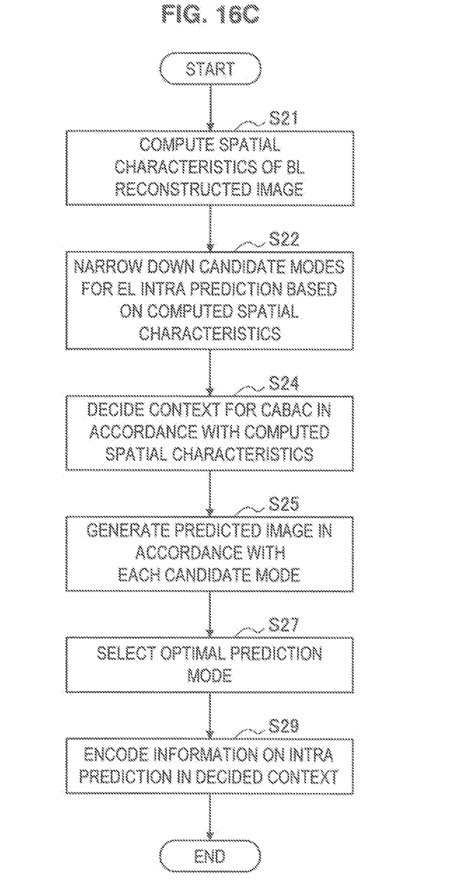

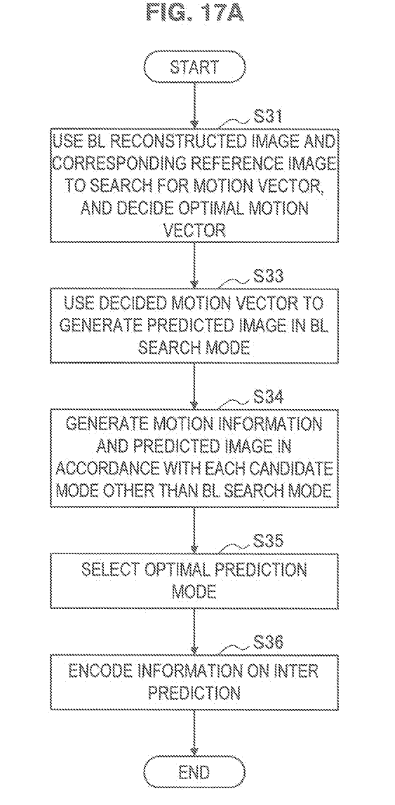

FIG. 16A is a flowchart illustrating a first example of a process flow relating to intra prediction in an encoding process on an enhancement layer (step S13 in FIG. 15).

FIG. 16A illustrates that, first of all, the characteristic computation section 31 computes the spatial characteristics of a reconstructed image of a base layer input from the intermediate processing section 3 by using the reconstructed image (step S21). Next, the intra prediction control section 32 narrows down candidate modes for intra prediction for the enhancement layer on the basis of the spatial characteristics computed by the characteristic computation section 31 (step S22). The prediction computation section 33 then generates a predicted image in prediction units by using reference image data in accordance with the narrowed-down one or more candidate modes (step S25). Next, the mode determination section 34 selects the optimal prediction mode on the basis of a cost function value calculated on the basis of the original image data and the predicted image data (step S27). The lossless encoding section 16 then encodes quantized data indicating a predicted error subjected to orthogonal transform and quantized, and encodes information on intra prediction input from the intra prediction section 30 (step S28).

### (2) Second Example

FIG. 16B is a flowchart illustrating a second example of a process flow relating to intra prediction in the encoding process on an enhancement layer (step S13 in FIG. 15).

FIG. 16B illustrates that, first of all, the characteristic computation section 31 computes the spatial characteristics of a reconstructed image of a base layer input from the intermediate processing section 3 by using the reconstructed image (step S21). Next, the intra prediction control section 32 decides mapping of a candidate mode for intra prediction for the enhancement layer and the mode number on the basis of the spatial characteristics computed by the characteristic computation section 31 (step S23). Mapping may be typically decided here such that a prediction mode more strongly relating to a computation result of the spatial characteristics has a lower mode number. Next, the prediction computation section 33 uses reference image data to generate a predicted image in prediction units in accordance with the one or more candidate modes in the prediction mode set (step S26). Next, the mode determination section 34 selects the optimal prediction mode on the basis of a cost function value calculated on the basis of the original image data and the predicted image data (step S27). The lossless encoding section 16 then encodes quantized data indicating a predicted error subjected to orthogonal transform and quantized, and encodes information on intra prediction input from the intra prediction section 30 (step S28).

### (3) Third Example

FIG. 16C is a flowchart illustrating a third example of a process flow relating to intra prediction in the encoding process on an enhancement layer (step S13 in FIG. 15).

FIG. 16C illustrates that, first of all, the characteristic computation section 31 computes the spatial characteristics of a reconstructed image of a base layer input from the intermediate processing section 3 by using the reconstructed image (step S21). Next, the intra prediction control section 32 narrows down candidate modes for intra prediction for the enhancement layer on the basis of the spatial characteristics computed by the characteristic computation section 31 (step S22). The intra prediction control section 32 decides a context for the CABAC in accordance with a computation result of the spatial characteristics by the characteristic computation section 31 (step S24). The prediction computation section 33 then uses reference image data to generate a predicted image in prediction units in accordance with the narrowed-down one or more candidate modes (step S25). Next, the mode determination section 34 selects the optimal prediction mode on the basis of a cost function value calculated on the basis of the original image data and the predicted image data (step S27). The lossless encoding section 16 encodes quantized data with the context decided in step S24, and encodes information on intra prediction input from the intra prediction section 30 (step S29).

### 3-3. Process Relating to Inter Prediction

### (1) First Example

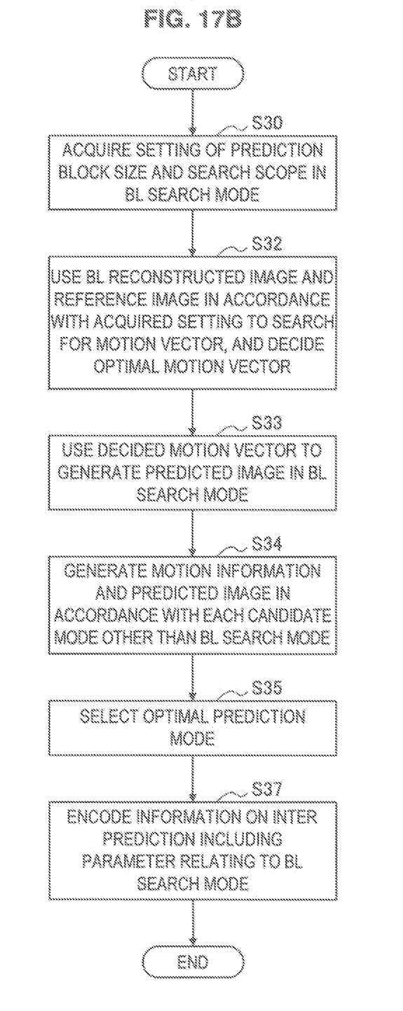

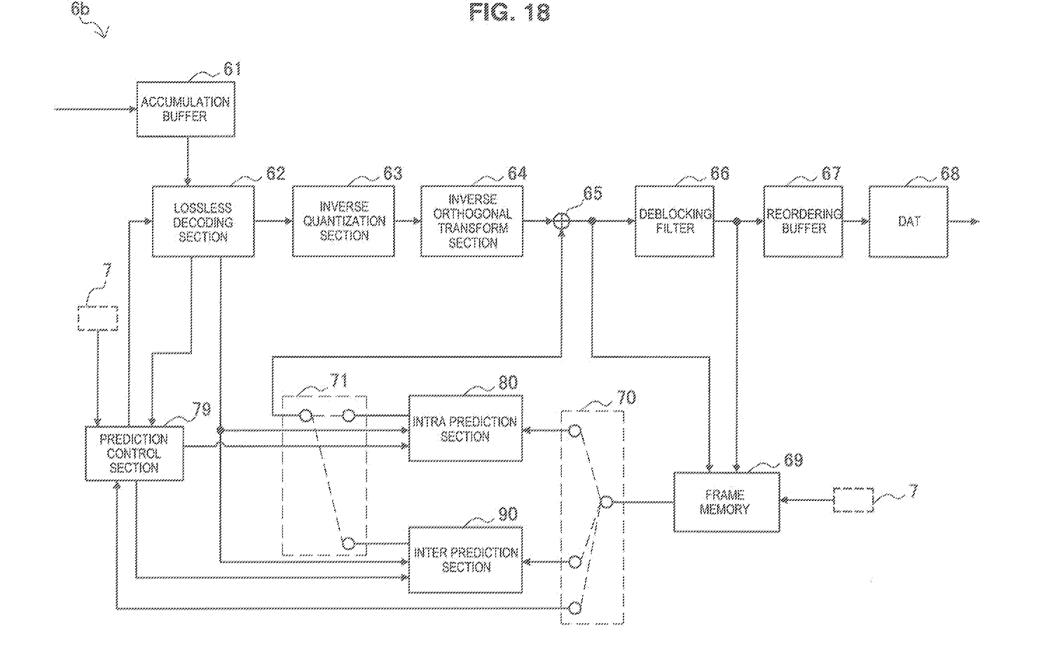

FIG. 17A is a flowchart illustrating a first example of a process flow relating to inter prediction in an encoding process on an enhancement layer (step S13 in FIG. 15).

FIG. 17A illustrates that, first of all, the search section 41 uses a reconstructed image of a base layer and the corresponding reference image input from the intermediate processing section 3 to search for a motion vector, and decides the optimal motion vector (step S31). Next, the prediction computation section 43 uses the decided motion vector to generate a predicted image in the BL search mode (step S33). The prediction computation section 43 also generates motion information and a predicted image in accordance with each of the other candidate modes in the prediction mode set (step S34). Next, the mode determination section 44 selects the optimal prediction mode from the prediction mode set including the BL search mode on the basis of a cost function value calculated on the basis of the original image data and the predicted image data (step S35). The lossless encoding section 16 then encodes quantized data indicating a predicted error subjected to orthogonal transform and quantized, and encodes information on inter prediction input from the inter prediction section 40 (step S36).

### (2) Second Example

FIG. 17B is a flowchart illustrating a second example of a process flow relating to inter prediction in the encoding process on an enhancement layer (step S13 in FIG. 15).

FIG. 17B illustrates that, first of all, the inter prediction control section 42 acquires the setting of the prediction block size and the search scope in the BL search mode (step S30). Next, the search section 41 uses a reconstructed image of a base layer and the corresponding reference image in accordance with the setting acquired by the inter prediction control section 42 to search for a motion vector, and decides the optimal motion vector (step S32). Next, the prediction computation section 43 uses the decided motion vector to generate a predicted image in the BL search mode (step S33). The prediction computation section 43 also generates motion information and a predicted image in accordance with each of the other candidate modes in the prediction mode set (step S34). Next, the mode determination section 44 selects the optimal prediction mode from the prediction mode set including the BL search mode on the basis of a cost function value calculated on the basis of the original image data and the predicted image data (step S35). The lossless encoding section 16 then encodes quantized data, and encodes information on inter prediction which may include a parameter indicating the prediction block size relating to the BL search mode and a parameter indicating the search scope (step S37).

### 4. EXAMPLE OF CONFIGURATION OF EL DECODING SECTION ACCORDING TO EMBODIMENT

### 4-1. Overall Configuration

FIG. 18 is a block diagram illustrating an example of the configuration of the EL decoding section 6b illustrated in FIG. 8. FIG. 18 illustrates that the EL decoding section 6b includes an accumulation buffer 61, a lossless decoding section 62, an inverse quantization section 63, an inverse orthogonal transform section 64, an addition section 65, a deblocking filter 66, a reordering buffer 67, a digital to analogue (D/A) conversion section 68, a frame memory 69, selectors 70 and 71, a prediction control section 79, an intra prediction section 80, and an inter prediction section 90.

The accumulation buffer 61 uses a storage medium to temporarily accumulate an encoded stream of an enhancement layer input from the inverse multiplexing section 5.

The lossless decoding section 62 decodes the encoded stream of the enhancement layer in accordance with the encoding scheme used for encoding, the encoded stream having been input from the accumulation buffer 61. The lossless decoding section 62 also decodes information multiplexed in the header region of the encoded stream. The information decoded by the lossless decoding section 62 may include, for example, information on intra prediction and information on inter prediction. The information on inter prediction may include an additional parameter such as a parameter indicating the prediction block size in search of a motion vector for a reconstructed image, and a parameter indicating the searched spatial scope. The lossless decoding section 62 outputs the information on intra prediction to the intra prediction section 80. The lossless decoding section 62 outputs the information on inter prediction to the inter prediction section 90.

The lossless decoding section 62 may decode encoded streams in accordance with a context-based encoding scheme such as the CABAC. In that case, the lossless decoding section 62 may, for example, execute a decoding process while switching contexts in accordance with the spatial characteristics of a reconstructed image. The spatial characteristics of a reconstructed image may be computed by the prediction control section 79, which will be described below.

The inverse quantization section 63 inversely quantizes quantized data which has been decoded by the lossless decoding section 62. The inverse orthogonal transform section 64 generates predicted error data by performing inverse orthogonal transform on transform coefficient data input from the inverse quantization section 63 in accordance with the orthogonal transform scheme used for encoding. The inverse orthogonal transform section 64 then outputs the generated predicted error data to the addition section 65.

The addition section 65 adds the predicted error data input from the inverse orthogonal transform section 64 and the predicted image data input from the selector 71 to generate decoded image data. The addition section 65 then outputs the generated decoded image data to the deblocking filter 66 and the frame memory 69.

The deblocking filter 66 removes blocking artifacts by filtering the decoded image data input from the addition section 65, and outputs the filtered decoded image data to the reordering buffer 67 and the frame memory 69.

The reordering buffer 67 generates a chronological series of image data by reordering images input from the deblocking filter 66. The reordering buffer 67 then outputs the generated image data to the D/A conversion section 68.

The D/A conversion section 68 converts the image data in a digital format input from the reordering buffer 67 into an image signal in an analogue format. The D/A conversion section 68 then causes an image of the enhancement layer to be displayed by outputting the analogue image signal to a display (not illustrated) connected to the image decoding device 60, for example.

The frame memory 69 uses a storage medium to store the decoded image data that has been input from the addition section 65 and has not yet been filtered, the decoded image data that has been input from the deblocking filter 66 and has been filtered, and the reconstructed image data of the base layer which has been input from the intermediate processing section 7.

The selector 70 switches the output destination of the image data from the frame memory 69 between the intra prediction section 80 and the inter prediction section 90 for each block in the image in accordance with mode information acquired by the lossless decoding section 62. For example, when the intra prediction mode is designated, the selector 70 outputs the decoded image data that has been supplied from the frame memory 69 and has not yet been filtered to the intra prediction section 80 as reference image data. When the inter prediction mode is designated, the selector 70 outputs the filtered decoded image data to the inter prediction section 90 as reference image data, and outputs the reconstructed image data of the base layer to the prediction control section 79.

The selector 71 switches the output source of the predicted image data to be supplied to the addition section 65 between the intra prediction section 80 and the inter prediction section 90 in accordance with the mode information acquired by the lossless decoding section 62. For example, when the intra prediction mode is designated, the selector 71 supplies the predicted image data output from the intra prediction section 80 to the addition section 65. When the inter prediction mode is designated, the selector 71 supplies the predicted image data output from the inter prediction section 90 to the addition section 65.

The prediction control section 79 uses the reconstructed image of the base layer generated by the BL decoding section 6a, and controls the prediction mode that is selected when the intra prediction section 80 and the inter prediction section 90 generate a predicted image of an enhancement layer. The prediction control section 79 may compute the spatial characteristics of the reconstructed image of the base layer, and may allow the lossless decoding section 62 to switch contexts for a lossless decoding process in accordance with the computed spatial characteristics.

The intra prediction section 80 performs an intra prediction process on the enhancement layer on the basis of the information on intra prediction input from the lossless decoding section 62 and the reference image data from the frame memory 69, and generates predicted image data. The intra prediction section 80 then outputs the generated predicted image data of the enhancement layer to the selector 71.

The inter prediction section 90 performs a motion compensation process on the enhancement layer on the basis of the information on inter prediction input from the lossless decoding section 62 and the reference image data from the frame memory 69, and generates predicted image data. The inter prediction section 90 then outputs the generated predicted image data of the enhancement layer to the selector 71.

### 4-2. Specific Configuration Relating to Intra Prediction

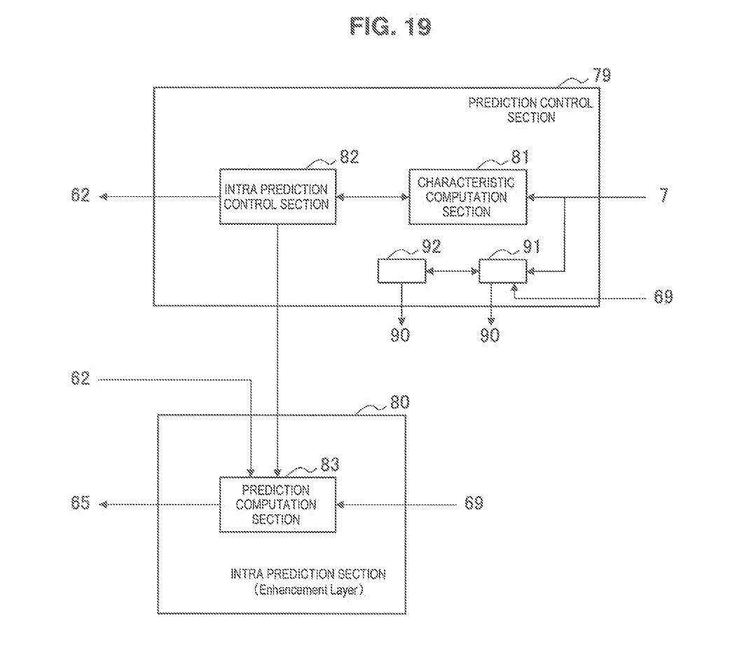

FIG. 19 is a block diagram illustrating an example of the specific configurations of the prediction control section 79 and the intra prediction section 80 illustrated in FIG. 18. FIG. 19 illustrates that the prediction control section 79 includes a characteristic computation section 81, an intra prediction control section 82, a search section 91, and an inter prediction control section 92. The intra prediction section 80 includes a prediction control section 83.

The characteristic computation section 81 computes the spatial characteristics of a reconstructed image of a base layer input from the intermediate processing section 7 by using the reconstructed image. The spatial characteristics computed by the characteristic computation section 81 may include at least one of the spatial correlation and dispersion of pixel values. As an example, the characteristic computation section 81 may compute the horizontal correlation C_{H} and the vertical correlation C_{V} for each prediction block in accordance with the expressions (6) and (7).

The intra prediction control section 82 controls a prediction mode for intra prediction executed by the intra prediction section 80 on the basis of the spatial characteristics computed by the characteristic computation section 81. More specifically, the intra prediction control section 82 may narrow down selectable candidate modes on the basis of the spatial characteristics such that the candidate modes include a prediction mode relating to a computation result of the spatial characteristics input from the characteristic computation section 81. FIGS. 11A to 11D illustrate four specific examples in which the candidate modes are narrowed down on the basis of the spatial characteristics. Narrowing down the candidate modes can reduce the amount of codes for prediction mode information decoded for an enhancement layer. The intra prediction control section 82 may set the mode numbers of the prediction modes instead of narrowing down the candidate modes such that a prediction mode strongly relating to a computation result of the spatial characteristics has a low number. The adaptive setting of mode numbers can reduce the amount of codes for prediction mode information resulted from variable-length encoding.

The intra prediction control section 82 may output, to the lossless decoding section 62, context information decided as a computation result of the spatial characteristics by the characteristic computation section 81 or decided in accordance with a computation result. This allows the lossless encoding section 62 to decode an encoded stream in a context-based encoding scheme while switching contexts in accordance with the spatial characteristics of a reconstructed image.

Once the intra prediction control section 82 decides a prediction mode, the prediction computation section 83 references the prediction mode information input from the lossless decoding section 62 to identify a prediction mode to be used for the generation of a predicted image. The prediction mode information indicates, for example, one of the prediction mode sets narrowed down by the intra prediction control section 82. When the narrowed-down prediction mode set includes only a single candidate mode, the prediction mode information may be omitted. The prediction computation section 83 generates a predicted image in prediction units in accordance with the identified prediction mode. The prediction computation section 83 then outputs the generated predicted image to the addition section 65.

### 4-3. Specific Configuration Relating to Inter Prediction

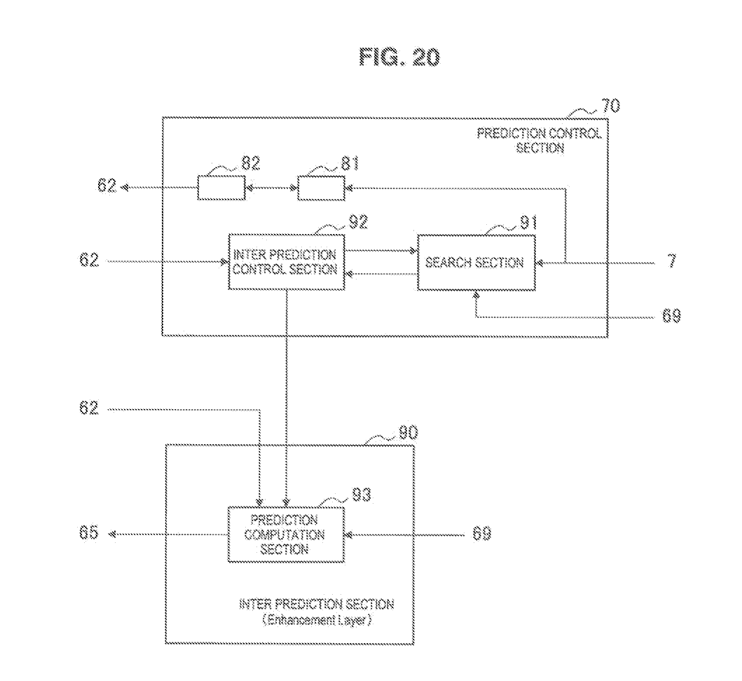

FIG. 20 is a block diagram illustrating an example of the specific configurations of the prediction control section 79 and the inter prediction section 90 illustrated in FIG. 18. FIG. 20 illustrates that the inter prediction section 90 includes a prediction computation section 93.

When prediction mode information included in information on inter prediction input from the lossless decoding section 62 indicates the BL search mode, the inter prediction control section 92 causes the search section 91 to execute a search process. The search section 91 searches for a motion vector by using a reconstructed image of a base layer and a reference image input from the intermediate processing section 7 to decide the motion vector optimal for compensating for the motion of a prediction block in the reconstructed image of the base layer. The search section 91 may search for a motion vector by using any known technique such as the block-matching algorithm and the gradient algorithm. The search section 91 may be implemented with an image processing engine that is implemented for searching for a motion vector in a post process for the purpose of achieving a high frame rate. The inter prediction control section 92 outputs, to the prediction computation section 93, the motion vector in the BL search mode which has been decided by the search section 91.

The BL search mode is a prediction mode for inter prediction which uses a motion vector decided by the search section 91 using a reconstructed image of a base layer. The BL search mode is added as a new candidate mode in the prediction mode set, or replaced with another prediction mode (e.g. temporal merge mode or temporal AMVP mode based on the temporal correlation between motion vectors).

The prediction computation section 93 references the prediction mode information input from the lossless decoding section 62 to identify a prediction mode to be used for the generation of a predicted image. The prediction mode information indicates, for example, one of the merge mode, the AMVP mode, and the BL search mode. The prediction computation section 93 generates a predicted image in prediction units in accordance with the identified prediction mode. For example, when the merge mode is identified, the prediction computation section 93 uses motion information set to a reference block designated by the merge information for the generation of a predicted image. Meanwhile, when the AMVP mode is identified, the prediction computation section 93 uses motion vector information reconstructed using difference motion vector information decoded by the lossless decoding section 62 for the generation of a predicted image. Furthermore, when the BL search mode is identified, the prediction computation section 93 uses a motion vector in the BL search mode which has been input from the inter prediction control section 92 for the generation of a predicted image. The prediction computation section 93 then outputs the generated predicted image to the addition section 65.

The inter prediction control section 92 may set the size and search scope of a prediction block in the BL search mode in a decoder in accordance with a parameter decoded from an encoded stream (e.g. VPS or SPS). The search section 91 executes a search process in accordance with this setting, which can save memory resources or shorten processing time needed for the search process.

### 5. FLOW OF DECODING PROCESS ACCORDING TO EMBODIMENT

### 5-1. Schematic Flow

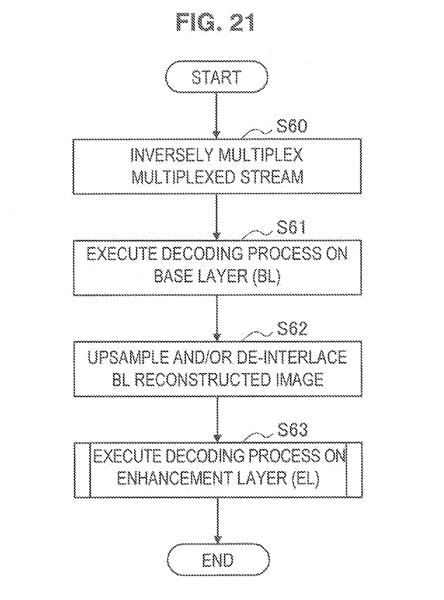

FIG. 21 is a flowchart illustrating an example of a schematic flow of a decoding process according to an embodiment. The description of process steps not directly relating to the technology according to the present disclosure is omitted in the drawings for brevity.

FIG. 21 illustrates that, first of all, the inverse multiplexing section 5 inversely multiplexes a multiplexed stream of a multi-layer to obtain an encoded stream of a base layer and an encoded stream of an enhancement layer (step S60).

Next, the BL decoding section 6a executes a decoding process on the base layer, and reconstructs a base layer image from the encoded stream of the base layer (step S61). The base layer image reconstructed here is output to the intermediate processing section 7 as a reconstructed image.

Next, when the reconstructed image of the base layer input from the BL decoding section 6a has been interlaced, the intermediate processing section 7 de-interlaces the reconstructed image. The intermediate processing section 7 upsamples the reconstructed image as needed (step S62).

Next, the EL decoding section 6b uses the reconstructed image processed by the intermediate processing section 7 to execute a decoding process on the enhancement layer, and reconstructs an enhancement layer image (step S63).

### 5-2. Process Relating to Intra Prediction

### (1) First Example

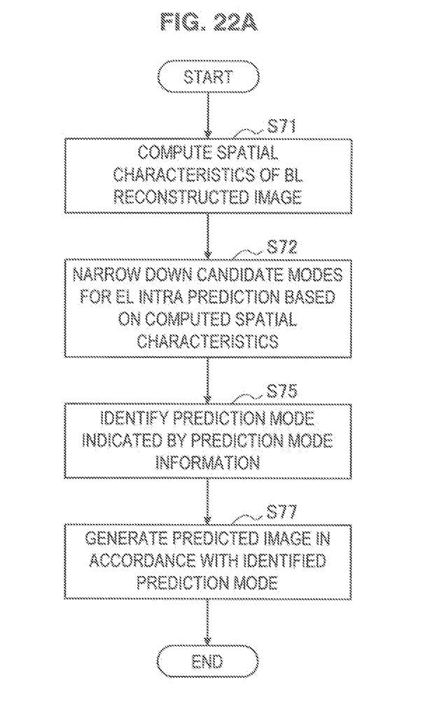

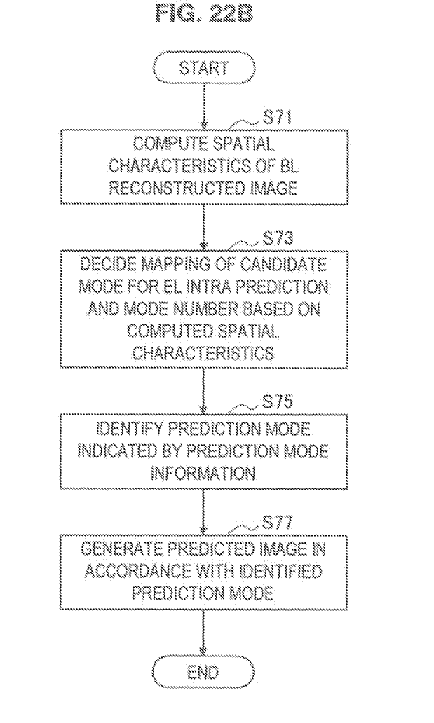

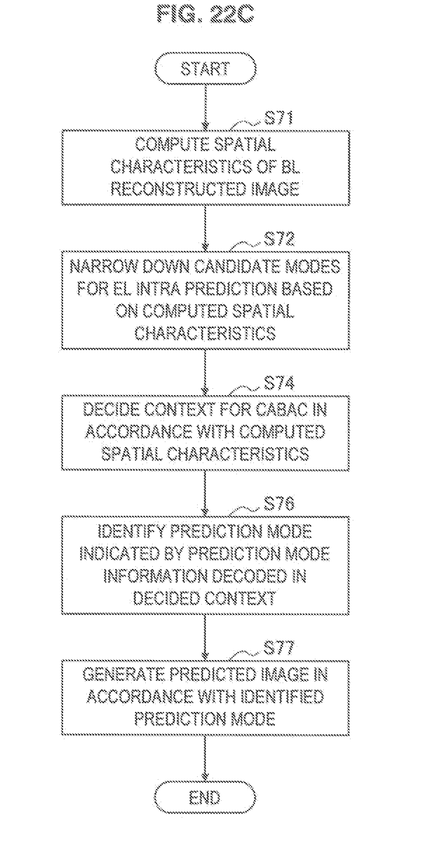

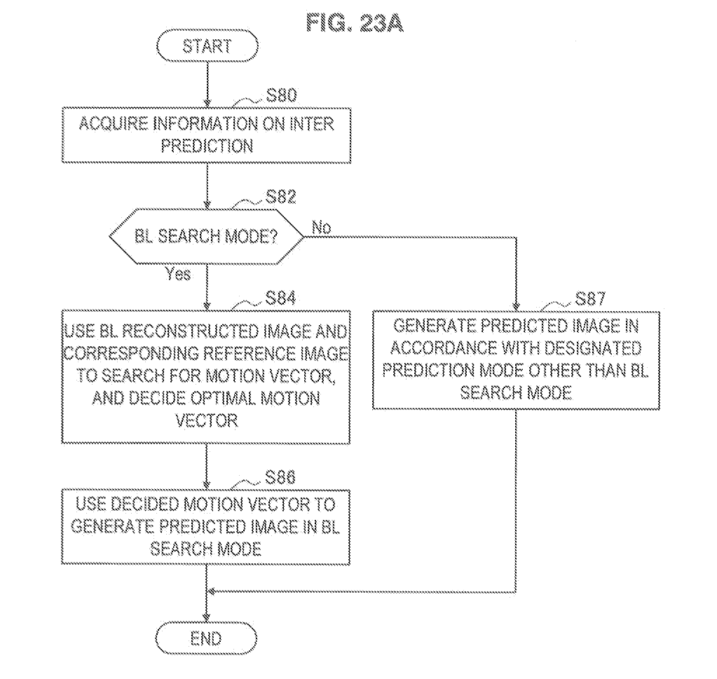

FIG. 22A is a flowchart illustrating a first example of a process flow relating to intra prediction in a decoding process on an enhancement layer (step S63 in FIG. 21).

FIG. 22A illustrates that, first of all, the characteristic computation section 81 computes the spatial characteristics of a reconstructed image of a base layer input from the intermediate processing section 7 by using the reconstructed image (step S71). Next, the intra prediction control section 82 narrows down candidate modes for intra prediction of an enhancement layer on the basis of the spatial characteristics computed by the characteristic computation section 81 (step S72). Next, the prediction computation section 83 identifies a prediction mode indicated by the decoded prediction mode information among the narrowed-down one or more candidate modes (step S75). The prediction computation section 83 then generates a predicted image in accordance with the identified prediction mode, and outputs the generated predicted image to the addition section 65 (step S77).

### (2) Second Example

FIG. 22B is a flowchart illustrating a second example of a process flow relating to intra prediction in the decoding process on an enhancement layer (step S63 in FIG. 21).

FIG. 22B illustrates that, first of all, the characteristic computation section 81 computes the spatial characteristics of a reconstructed image of a base layer input from the intermediate processing section 7 by using the reconstructed image (step S71). Next the intra prediction control section 82 decides mapping of a candidate mode for intra prediction of the enhancement layer and a mode number on the basis of the spatial characteristics computed by the characteristic computation section 81 (step S73). Mapping may be typically decided here such that a prediction mode more strongly relating to a computation result of the spatial characteristics has a lower mode number. Next, the prediction computation section 83 identifies a prediction mode indicated by the prediction mode information among the one or more candidate modes in the prediction mode set in accordance with the mapping decided in step S73 (step S75). The prediction computation section 83 then generates a predicted image in accordance with the identified prediction mode, and outputs the generated predicted image to the addition section 65 (step S77).

### (3) Third Example

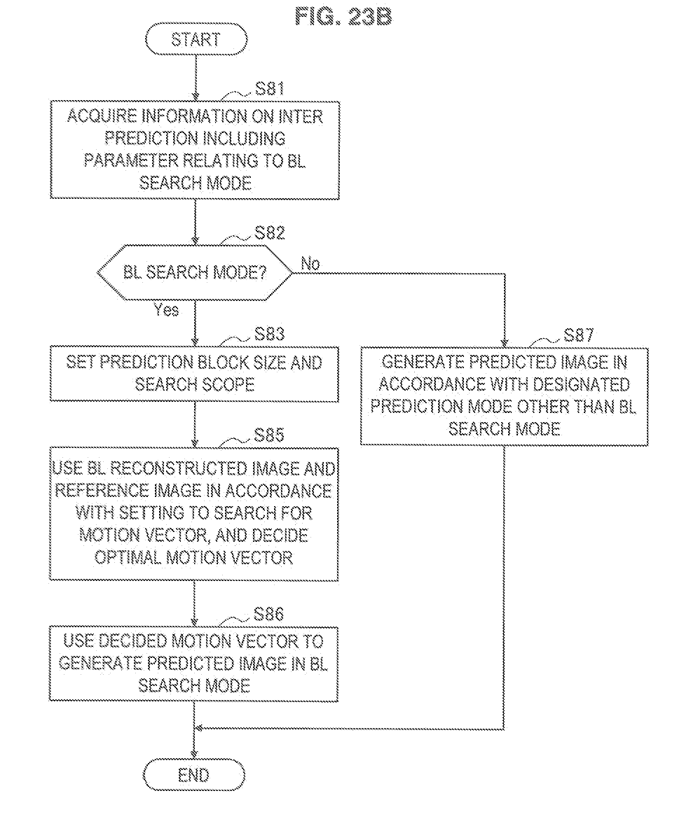

FIG. 22C is a flowchart illustrating a third example of a process flow relating to intra prediction in the decoding process on an enhancement layer (step S63 in FIG. 23).

FIG. 22C illustrates that, first of all, the characteristic computation section 81 computes the spatial characteristics of a reconstructed image of a base layer input from the intermediate processing section 7 by using the reconstructed image (step S71). Next, the intra prediction control section 82 narrows down candidate modes for intra prediction of the enhancement layer on the basis of the spatial characteristics computed by the characteristic computation section 81 (step S72). The intra prediction control section 82 decides a context for the CABAC in accordance with a computation result of the spatial characteristics by the characteristic computation section 81 (step S74). Next, the prediction computation section 83 identifies a prediction mode indicated by the prediction mode information decoded in the decided context among the narrowed-down one or more candidate modes (step S76). The prediction computation section 83 then generates a predicted image in accordance with the identified prediction mode, and outputs the generated predicted image to the addition section 65 (step S77).

### 5-3. Process Relating to Inter Prediction

### (1) First Example

FIG. 23A is a flowchart illustrating a first example of a process flow relating to inter prediction in a decoding process on an enhancement layer (step S63 in FIG. 21).

FIG. 23A illustrates that, first of all, the inter prediction control section 92 acquires information on inter prediction decoded by the lossless decoding section 62 (step S80). Next, the inter prediction control section 92 determines whether the prediction mode information included in the information on inter prediction indicates the BL search mode (step S82).

When the prediction mode information indicates the BL search mode in step S82, the search section 91 uses a reconstructed image of a base layer input from the intermediate processing section 7 and the corresponding reference image to search for a motion vector, and decides the optimal motion vector (step S84). The prediction computation section 93 then uses the decided motion vector to generate a predicted image in the BL search mode (step S86).

Meanwhile, when the prediction mode information indicates a prediction mode other than the BL search mode in step S82, the prediction computation section 93 identifies a motion vector and a reference image in accordance with a prediction mode designated by the prediction mode information to generate a predicted image (step S87).

### (2) Second Example

FIG. 23B is a flowchart illustrating a second example of a process flow relating to inter prediction in the decoding process on an enhancement layer (step S63 in FIG. 21).

FIG. 23B illustrates that, first of all, the inter prediction control section 92 acquires information on inter prediction decoded by the lossless decoding section 62 (step S81). The information on inter prediction acquired here may include a parameter indicating the prediction block size and search scope in the BL search mode. Next, the inter prediction control section 92 determines whether prediction mode information included in the information on inter prediction indicates the BL search mode (step S82).

When the prediction mode information indicates the BL search mode in step S82, the inter prediction control section 92 sets the prediction block size and search scope in the BL search mode to the search section 91 in accordance with the parameter acquired in step S80 (step S83). Next, the search section 91 uses a reconstructed image of a base layer and the corresponding reference image input from the intermediate processing section 7 to search for a motion vector in accordance with the setting, and decides the optimal motion vector (step S85). The prediction computation section 93 then uses the decided motion vector to generate a predicted image in the BL search mode (step S86).

Meanwhile, when the prediction mode information indicates a prediction mode other than the BL search mode in step S82, the prediction computation section 93 identifies a motion vector and a reference image in accordance with a prediction mode designated by the prediction mode information to generate a predicted image (step S87).

### 6. APPLICATIONS

The image encoding device 10 and the image decoding device 60 according to the embodiment may be applied to various electronic devices such as transmitters and receivers for satellite broadcasting, cable broadcasting such as cable TV, distribution on the Internet, distribution to terminals via cellular communication and the like, recording devices that record images in a medium such as optical discs, magnetic disks and flash memory, and reproduction devices that reproduce images from such storage medium. Four applications will be described below.

### 6-1. First Application

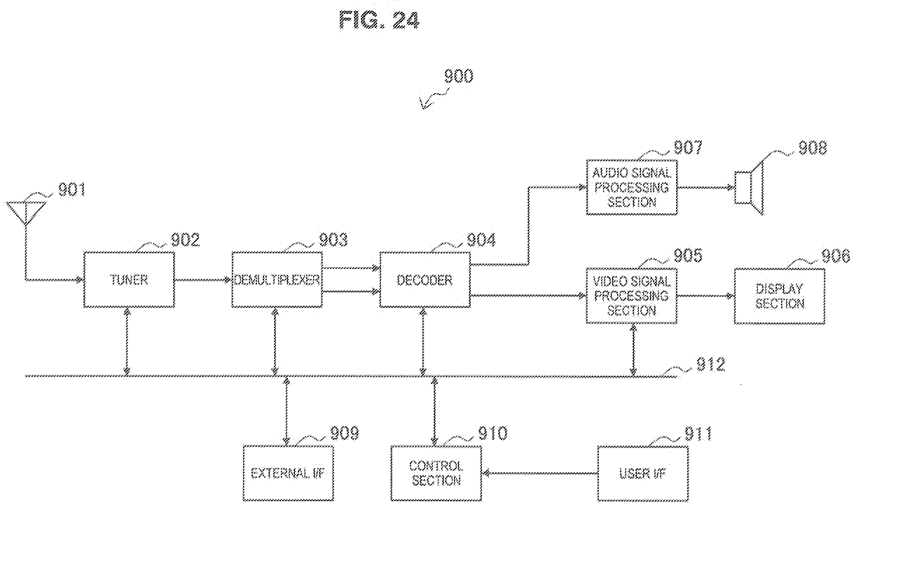

FIG. 24 illustrates an example of a schematic configuration of a television device to which the embodiment is applied. A television device 900 includes an antenna 901, a tuner 902, a demultiplexer 903, a decoder 904, an video signal processing section 905, a display section 906, an audio signal processing section 907, a speaker 908, an external interface 909, a control section 910, a user interface 911, and a bus 912.

The tuner 902 extracts a signal of a desired channel from broadcast signals received via the antenna 901, and demodulates the extracted signal. The tuner 902 then outputs an encoded bit stream obtained through the demodulation to the demultiplexer 903. That is, the tuner 902 serves as a transmission means of the television device 900 for receiving an encoded stream in which an image is encoded.

The demultiplexer 903 demultiplexes the encoded bit stream to obtain a video stream and an audio stream of a program to be viewed, and outputs each stream obtained through the demultiplexing to the decoder 904. The demultiplexer 903 also extracts auxiliary data such as electronic program guides (EPGs) from the encoded bit stream, and supplies the extracted data to the control section 910. Additionally, the demultiplexer 903 may perform descrambling when the encoded bit stream has been scrambled.

The decoder 904 decodes the video stream and the audio stream input from the demultiplexer 903. The decoder 904 then outputs video data generated in the decoding process to the video signal processing section 905. The decoder 904 also outputs the audio data generated in the decoding process to the audio signal processing section 907.

The video signal processing section 905 reproduces the video data input from the decoder 904, and causes the display section 906 to display the video. The video signal processing section 905 may also cause the display section 906 to display an application screen supplied via a network. Further, the video signal processing section 905 may perform an additional process such as noise removal, for example, on the video data in accordance with the setting. Furthermore, the video signal processing section 905 may generate an image of a graphical user interface (GUI) such as a menu, a button and a cursor, and superimpose the generated image on an output image.

The display section 906 is driven by a drive signal supplied from the video signal processing section 905, and displays a video or an image on a video screen of a display device (e.g. liquid crystal display, plasma display, OLED, etc.).

The audio signal processing section 907 performs a reproduction process such as D/A conversion and amplification on the audio data input from the decoder 904, and outputs a sound from the speaker 908. The audio signal processing section 907 may also perform an additional process such as noise removal on the audio data.

The external interface 909 is an interface for connecting the television device 900 to an external device or a network. For example, a video stream or an audio stream received via the external interface 909 may be decoded by the decoder 904. That is, the external interface 909 also serves as a transmission means of the television device 900 for receiving an encoded stream in which an image is encoded.

The control section 910 includes a processor such as a central processing unit (CPU), and a memory such as random access memory (RAM) and read only memory (ROM). The memory stores a program to be executed by the CPU, program data, EPG data, data acquired via a network, and the like. The program stored in the memory is read out and executed by the CPU at the time of activation of the television device 900, for example. The CPU controls the operation of the television device 900, for example, in accordance with an operation signal input from the user interface 911 by executing the program.

The user interface 911 is connected to the control section 910. The user interface 911 includes, for example, a button and a switch used for a user to operate the television device 900, and a receiving section for a remote control signal. The user interface 911 detects an operation of a user via these structural elements, generates an operation signal, and outputs the generated operation signal to the control section 910.

The bus 912 connects the tuner 902, the demultiplexer 903, the decoder 904, the video signal processing section 905, the audio signal processing section 907, the external interface 909, and the control section 910 to each other.

The decoder 904 has a function of the image decoding device 60 according to the embodiment in the television device 900 configured in this manner. When the BLR scalability is implemented in a plurality of layers during scalable video decoding of an image on the television device 900, this can improve a way of reusing a reconstructed image to reduce the amount of codes for an enhancement layer.

### 6-2. Second Application

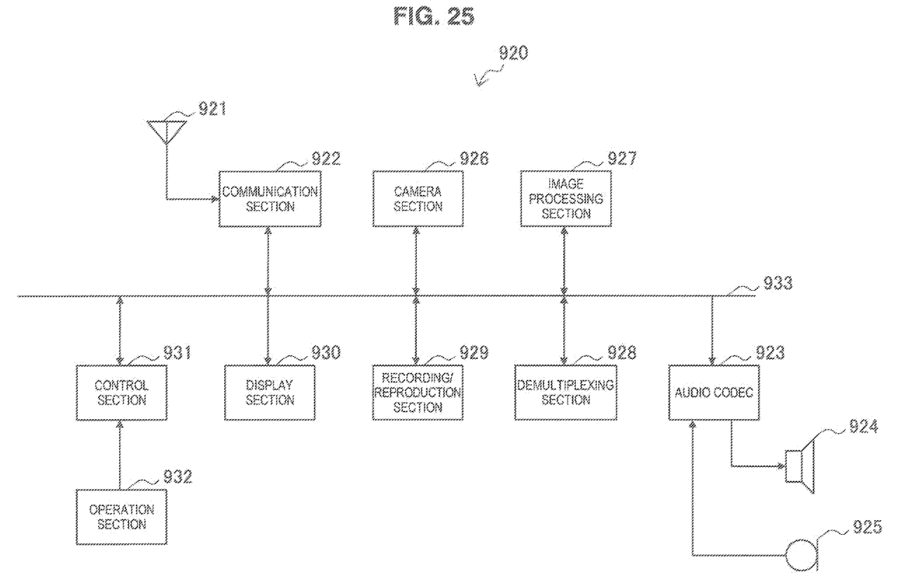

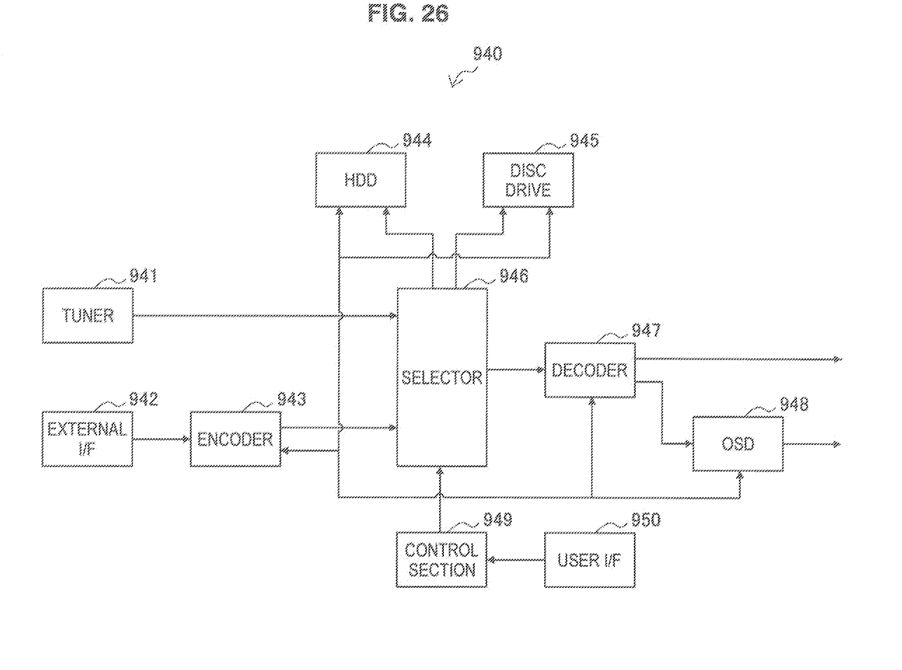

FIG. 25 illustrates an example of a schematic configuration of a mobile phone to which the embodiment is applied. A mobile phone 920 includes an antenna 921, a communication section 922, an audio codec 923, a speaker 924, a microphone 925, a camera section 926, an image processing section 927, a demultiplexing section 928, a recording/reproduction section 929, a display section 930, a control section 931, an operation section 932, and a bus 933.

The antenna 921 is connected to the communication section 922. The speaker 924 and the microphone 925 are connected to the audio codec 923. The operation section 932 is connected to the control section 931. The bus 933 connects the communication section 922, the audio codec 923, the camera section 926, the image processing section 927, the demultiplexing section 928, the recording/reproduction section 929, the display section 930, and the control section 931 to each other.

The mobile phone 920 performs an operation such as transmission and reception of an audio signal, transmission and reception of email or image data, image capturing, and recording of data in various operation modes including an audio call mode, a data communication mode, an image capturing mode, and a videophone mode.

An analogue audio signal generated by the microphone 925 is supplied to the audio codec 923 in the audio call mode. The audio codec 923 converts the analogue audio signal into audio data, has the converted audio data subjected to the A/D conversion, and compresses the converted data. The audio codec 923 then outputs the compressed audio data to the communication section 922. The communication section 922 encodes and modulates the audio data, and generates a transmission signal. The communication section 922 then transmits the generated transmission signal to a base station (not illustrated) via the antenna 921. The communication section 922 also amplifies a wireless signal received via the antenna 921 and converts the frequency of the wireless signal to acquire a received signal. The communication section 922 then demodulates and decodes the received signal, generates audio data, and outputs the generated audio data to the audio codec 923. The audio codec 923 extends the audio data, has the audio data subjected to the D/A conversion, and generates an analogue audio signal. The audio codec 923 then supplies the generated audio signal to the speaker 924 to output a sound.

The control section 931 also generates text data in accordance with an operation made by a user via the operation section 932, the text data, for example, composing email. Moreover, the control section 931 causes the display section 930 to display the text. Furthermore, the control section 931 generates email data in accordance with a transmission instruction from a user via the operation section 932, and outputs the generated email data to the communication section 922. The communication section 922 encodes and modulates the email data, and generates a transmission signal. The communication section 922 then transmits the generated transmission signal to a base station (not illustrated) via the antenna 921. The communication section 922 also amplifies a wireless signal received via the antenna 921 and converts the frequency of the wireless signal to acquire a received signal. The communication section 922 then demodulates and decodes the received signal to restore the email data, and outputs the restored email data to the control section 931. The control section 931 causes the display section 930 to display the content of the email, and also causes the storage medium of the recording/reproduction section 929 to store the email data.

The recording/reproduction section 929 includes a readable and writable storage medium. For example, the storage medium may be a built-in storage medium such as RAM and flash memory, or an externally mounted storage medium such as hard disks, magnetic disks, magneto-optical disks, optical discs, USB memory, and memory cards.

Furthermore, the camera section 926, for example, captures an image of a subject to generate image data, and outputs the generated image data to the image processing section 927 in the image capturing mode. The image processing section 927 encodes the image data input from the camera section 926, and causes the storage medium of the recording/reproduction section 929 to store the encoded stream.

Furthermore, the demultiplexing section 928, for example, multiplexes a video stream encoded by the image processing section 927 and an audio stream input from the audio codec 923, and outputs the multiplexed stream to the communication section 922 in the videophone mode. The communication section 922 encodes and modulates the stream, and generates a transmission signal. The communication section 922 then transmits the generated transmission signal to a base station (not illustrated) via the antenna 921. The communication section 922 also amplifies a wireless signal received via the antenna 921 and converts the frequency of the wireless signal to acquire a received signal. These transmission signal and received signal may include an encoded bit stream. The communication section 922 then demodulates and decodes the received signal to restore the stream, and outputs the restored stream to the demultiplexing section 928. The demultiplexing section 928 demultiplexes the input stream to obtain a video stream and an audio stream, and outputs the video stream to the image processing section 927 and the audio stream to the audio codec 923. The image processing section 927 decodes the video stream, and generates video data. The video data is supplied to the display section 930, and a series of images is displayed by the display section 930. The audio codec 923 extends the audio stream, has the audio stream subjected to the D/A conversion, and generates an analogue audio signal. The audio codec 923 then supplies the generated audio signal to the speaker 924, and causes a sound to be output.

The image processing section 927 has a function of the image encoding device 10 and the image decoding device 60 according to the embodiment in the mobile phone 920 configured in this manner. When the BLR scalability is implemented in a plurality of layers during scalable video coding and decoding of an image on the mobile phone 920, this can improve a way of reusing a reconstructed image to reduce the amount of codes for an enhancement layer.

### 6-3. Third Application

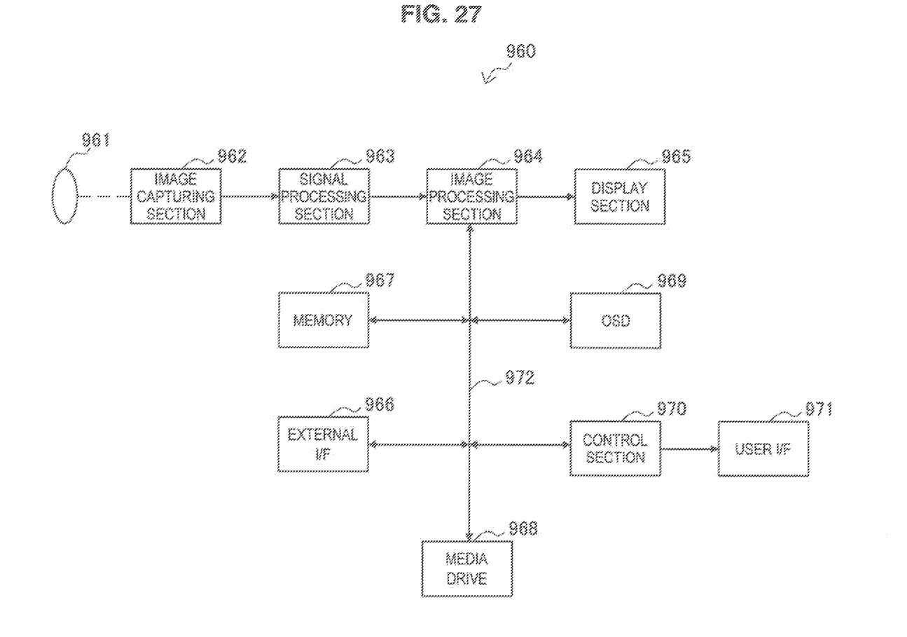

FIG. 26 illustrates an example of a schematic configuration of a recording/reproduction device to which the embodiment is applied. A recording/reproduction device 940, for example, encodes audio data and video data of a received broadcast program and records the encoded audio data and the encoded video data in a recording medium. For example, the recording/reproduction device 940 may also encode audio data and video data acquired from another device and record the encoded audio data and the encoded video data in a recording medium. Furthermore, the recording/reproduction device 940, for example, uses a monitor or a speaker to reproduce the data recorded in the recording medium in accordance with an instruction of a user. At this time, the recording/reproduction device 940 decodes the audio data and the video data.

The recording/reproduction device 940 includes a tuner 941, an external interface 942, an encoder 943, a hard disk drive (HDD) 944, a disc drive 945, a selector 946, a decoder 947, an on-screen display (OSD) 948, a control section 949, and a user interface 950.

The tuner 941 extracts a signal of a desired channel from broadcast signals received via an antenna (not shown), and demodulates the extracted signal. The tuner 941 then outputs an encoded bit stream obtained through the demodulation to the selector 946. That is, the tuner 941 serves as a transmission means of the recording/reproduction device 940.

The external interface 942 is an interface for connecting the recording/reproduction device 940 to an external device or a network. For example, the external interface 942 may be an IEEE 1394 interface, a network interface, an USB interface, a flash memory interface, or the like. For example, video data and audio data received via the external interface 942 are input to the encoder 943. That is, the external interface 942 serves as a transmission means of the recording/reproduction device 940.

When the video data and the audio data input from the external interface 942 have not been encoded, the encoder 943 encodes the video data and the audio data. The encoder 943 then outputs an encoded bit stream to the selector 946.

The HDD 944 records, in an internal hard disk, the encoded bit stream in which content data of a video and a sound is compressed, various programs, and other pieces of data. The HDD 944 also reads out these pieces of data from the hard disk at the time of reproducing a video or a sound.

The disc drive 945 records and reads out data in a recording medium that is mounted. The recording medium that is mounted on the disc drive 945 may be, for example, a DVD disc (DVD-Video, DVD-RAM, DVD-R, DVD-RW, a DVD+R, DVD+RW, etc.), a Blu-ray (registered trademark) disc, or the like.

The selector 946 selects, at the time of recording a video or a sound, an encoded bit stream input from the tuner 941 or the encoder 943, and outputs the selected encoded bit stream to the HDD 944 or the disc drive 945. The selector 946 also outputs, at the time of reproducing a video or a sound, an encoded bit stream input from the HDD 944 or the disc drive 945 to the decoder 947.

The decoder 947 decodes the encoded bit stream, and generates video data and audio data. The decoder 947 then outputs the generated video data to the OSD 948. The decoder 904 also outputs the generated audio data to an external speaker.

The OSD 948 reproduces the video data input from the decoder 947, and displays a video. The OSD 948 may also superimpose an image of a GUI such as a menu, a button, and a cursor on a displayed video.

The control section 949 includes a processor such as a CPU, and a memory such as RAM and ROM. The memory stores a program to be executed by the CPU, program data, and the like. For example, a program stored in the memory is read out and executed by the CPU at the time of activation of the recording/reproduction device 940. The CPU controls the operation of the recording/reproduction device 940, for example, in accordance with an operation signal input from the user interface 950 by executing the program.

The user interface 950 is connected to the control section 949. The user interface 950 includes, for example, a button and a switch used for a user to operate the recording/reproduction device 940, and a receiving section for a remote control signal. The user interface 950 detects an operation made by a user via these structural elements, generates an operation signal, and outputs the generated operation signal to the control section 949.

The encoder 943 has a function of the image encoding device 10 according to the embodiment in the recording/reproduction device 940 configured in this manner. The decoder 947 also has a function of the image decoding device 60 according to the embodiment. When the BLR scalability is implemented in a plurality of layers during scalable video coding and decoding of an image on the recording/reproduction device 940, this can improve a way of reusing a reconstructed image to reduce the amount of codes for an enhancement layer.

### 6-4. Fourth Application

FIG. 27 illustrates an example of a schematic configuration of an image capturing device to which the embodiment is applied. An image capturing device 960 captures an image of a subject to generate an image, encodes the image data, and records the image data in a recording medium.

The image capturing device 960 includes an optical block 961, an image capturing section 962, a signal processing section 963, an image processing section 964, a display section 965, an external interface 966, a memory 967, a media drive 968, an OSD 969, a control section 970, a user interface 971, and a bus 972.

The optical block 961 is connected to the image capturing section 962. The image capturing section 962 is connected to the signal processing section 963. The display section 965 is connected to the image processing section 964. The user interface 971 is connected to the control section 970. The bus 972 connects the image processing section 964, the external interface 966, the memory 967, the media drive 968, the OSD 969, and the control section 970 to each other.

The optical block 961 includes a focus lens, an aperture stop mechanism, and the like. The optical block 961 forms an optical image of a subject on an image capturing surface of the image capturing section 962. The image capturing section 962 includes an image sensor such as a CCD and CMOS, and converts the optical image formed on the image capturing surface into an image signal which is an electrical signal through photoelectric conversion. The image capturing section 962 then outputs the image signal to the signal processing section 963.

The signal processing section 963 performs various camera signal processes such as knee correction, gamma correction, and color correction on the image signal input from the image capturing section 962. The signal processing section 963 outputs the image data subjected to the camera signal process to the image processing section 964.

The image processing section 964 encodes the image data input from the signal processing section 963, and generates encoded data. The image processing section 964 then outputs the generated encoded data to the external interface 966 or the media drive 968. The image processing section 964 also decodes encoded data input from the external interface 966 or the media drive 968, and generates image data. The image processing section 964 then outputs the generated image data to the display section 965. The image processing section 964 may also output the image data input from the signal processing section 963 to the display section 965, and cause the image to be displayed. Furthermore, the image processing section 964 may superimpose data for display acquired from the OSD 969 on an image to be output to the display section 965.

The OSD 969 generates an image of a GUI such as a menu, a button, and a cursor, and outputs the generated image to the image processing section 964.

The external interface 966 is configured, for example, as an USB input/output terminal. The external interface 966 connects the image capturing device 960 and a printer, for example, at the time of printing an image. A drive is further connected to the external interface 966 as needed. A removable medium such as magnetic disks and optical discs is mounted on the drive, and a program read out from the removable medium may be installed in the image capturing device 960. Furthermore, the external interface 966 may be configured as a network interface to be connected to a network such as a LAN and the Internet. That is, the external interface 966 serves as a transmission means of the image capturing device 960.

A recording medium to be mounted on the media drive 968 may be a readable and writable removable medium such as magnetic disks, magneto-optical disks, optical discs, and semiconductor memory. The recording medium may also be fixedly mounted on the media drive 968, configuring a non-transportable storage section such as built-in hard disk drives or a solid state drives (SSDs).

The control section 970 includes a processor such as a CPU, and a memory such as RAM and ROM. The memory stores a program to be executed by the CPU, program data, and the like. A program stored in the memory is read out and executed by the CPU, for example, at the time of activation of the image capturing device 960. The CPU controls the operation of the image capturing device 960, for example, in accordance with an operation signal input from the user interface 971 by executing the program.

The user interface 971 is connected to the control section 970. The user interface 971 includes, for example, a button, a switch, and the like used for a user to operate the image capturing device 960. The user interface 971 detects an operation made by a user via these structural elements, generates an operation signal, and outputs the generated operation signal to the control section 970.

The image processing section 964 has a function of the image encoding device 10 and the image decoding device 60 according to the embodiment in the image capturing device 960 configured in this manner. When the BLR scalability is implemented in a plurality of layers during scalable video coding and decoding of an image on the image capturing device 960, this can improve a way of reusing a reconstructed image to reduce the amount of codes for an enhancement layer.

### 7. CONCLUSION

An image encoding device 10 and an image decoding device 60 according to an embodiment have been described so far using FIGS. 1 to 27. According to the embodiment, a reconstructed image generated by decoding an encoded stream of a base layer is used, and a prediction mode selected at the generation of a predicted image of an enhancement layer is controlled. It is thus possible to reduce a larger amount of codes for an enhancement layer and achieve higher encoding efficiency than the technique in which an enhancement layer, completely independently from a base layer, is subjected to intra prediction and inter prediction.

Furthermore, according to the embodiment, a prediction mode for intra prediction is controlled on the basis of the spatial characteristics of a reconstructed image of a base layer. For example, when the candidate modes for intra prediction are narrowed down on the basis of a computation result of the spatial characteristics, the number of candidate modes in the prediction mode set decreases. Meanwhile, when the mode numbers of prediction modes are adaptively set on the basis of a computation result of the spatial characteristics, a prediction mode more likely to occur is mapped to a lower number. The amount of codes for prediction mode information of an enhancement layer resulting from the variable-length encoding can be thus more efficiently reduced using the correlational characteristic similarity between layers.

According to the embodiment, a new prediction mode is available as a candidate mode for inter prediction, the new prediction mode using a motion vector decided with a reconstructed image of a base layer. The amount of codes for predicted error data of an enhancement layer can be thus reduced as a result of the enhanced prediction accuracy of inter prediction.

The description has been made chiefly for the example in which information on intra prediction and information on inter prediction are multiplexed in the header of an encoded stream, and transmitted from the encoding side to the decoding side. However, a technique of transmitting such information is not limited to this example. For example, the information is not multiplexed into an encoded bit stream, but may be transmitted or recorded as separate data associated with the encoded bit stream. The term “associate” means that an image (which may also be a part of an image such as a slice and a block) included in the bit stream may be linked with information corresponding to the image at the time of decoding. That is, the information may be transmitted over a transmission path different from that of an image (or a bit stream). The information may also be recorded in a recording medium different from that of an image (or a bit stream) (or a different recording area in the same recording medium). The information and the image (or the bit stream) may be further associated with each other in given units such as multiple frames, one frame, and a part of a frame.

The preferred embodiments of the present disclosure have been described above with reference to the accompanying drawings, whilst the present disclosure is not limited to the above examples, of course. A person skilled in the art may find various alterations and modifications within the scope of the appended claims, and it should be understood that they will naturally come under the technical scope of the present disclosure.

Additionally, the technology of the present disclosure may also be configured as below.

(1)

An image processing device including:

a base layer decoding section configured to decode an encoded stream of a base layer, and to generate a reconstructed image of the base layer; and

a prediction control section configured to use the reconstructed image generated by the base layer decoding section, and to control a prediction mode that is selected at generation of a predicted image of an enhancement layer.

(2)

The image processing device according to (1),

wherein the prediction control section uses the reconstructed image to compute a spatial characteristic of the reconstructed image, and controls a prediction mode for intra prediction on the basis of the computed spatial characteristic.

(3)

The image processing device according to (2),

wherein the spatial characteristic includes at least one of a spatial correlation and dispersion of pixel values.

(4)

The image processing device according to (2) or (3),

wherein the prediction control section narrows down selectable candidate modes on the basis of the spatial characteristic in a manner that a prediction mode relating to a computation result of the spatial characteristic is included in the candidate modes.

(5)

The image processing device according to (2) or (3),

wherein the prediction control section sets a mode number of a prediction mode in a manner that a prediction mode more strongly relating to a computation result of the spatial characteristic has a lower mode number.

(6)

The image processing device according to (1),

wherein the prediction control section includes a prediction mode for inter prediction in a candidate mode that is selectable at generation of the predicted image of the enhancement layer, the prediction mode for inter prediction using a motion vector decided with the reconstructed image.

(7)

The image processing device according to (6),

wherein the prediction control section searches for an optimal motion vector by using the reconstructed image of the base layer and a reference image corresponding to the reconstructed image to decide the motion vector.

(8)

The image processing device according to (6) or (7),

wherein the prediction control section adds the prediction mode to a set of candidate modes for inter prediction, the prediction mode using the motion vector decided with the reconstructed image.

(9)

The image processing device according to (6) or (7),

wherein the prediction control section replaces the prediction mode with another mode in a set of candidate modes for inter prediction, the prediction mode using the motion vector decided with the reconstructed image.

(10)

The image processing device according to (9),

wherein the other mode is based on a temporal correlation of motion vectors.

(11)

The image processing device according to (7),

wherein the prediction control section does a search in each of prediction blocks having a larger size than a smallest prediction block size used for searching the enhancement layer for a motion vector.

(12)

The image processing device according to any one of (2) to (5), further including:

a decoding section configured to decode an encoded stream of the enhancement layer in a context-based encoding scheme while switching contexts in accordance with the spatial characteristic of the reconstructed image.

(13)

The image processing device according to any one of (2) to (5), further including:

an encoding section configured to generate an encoded stream of the enhancement layer in a context-based encoding scheme while switching contexts in accordance with the spatial characteristic of the reconstructed image.

(14)

The image processing device according to (11), further including:

a decoding section configured to decode a parameter indicating at least one of the size of the prediction block, and a spatial scope of the prediction block searched by the prediction control section.

(15)

The image processing device according to (11), further including:

an encoding section configured to encode a parameter indicating at least one of the size of the prediction block, and a spatial scope of the prediction block searched by the prediction control section.

(16)

The image processing device according to any one of (1) to (15), further including:

an upsampling section configured to upsample the reconstructed image in accordance with a resolution ratio between the base layer and the enhancement layer.

wherein the prediction control section uses the upsampled reconstructed image to control the prediction mode.

(17)

The image processing device according to any one of (1) to (15), further including:

a de-interlace section configured to de-interlace the reconstructed image,

wherein the prediction control section uses the de-interlaced reconstructed image to control the prediction mode.

(18)

The image processing device according to any one of (1) to (17),

wherein base layer reconstructed pixel only (BLR) scalability is implemented on the base layer and the enhancement layer.

(19)

An image processing method including:

decoding an encoded stream of a base layer, and generating a reconstructed image of the base layer, and

using the generated reconstructed image, and controlling a prediction mode that is selected at generation of a predicted image of an enhancement layer.

### REFERENCE SIGNS LIST

10 image encoding device (image processing device)
1a base layer encoding section
2 local decoder (base layer decoding section)
3 intermediate processing section (upsampling section/de-interlace section)
1b enhancement layer encoding section
29 prediction control section
30 intra prediction section
40 inter prediction section
60 image decoding device (image processing device)
6a base layer decoding section
7 intermediate processing section (upsampling section/de-interlace section)
6b enhancement layer decoding section
79 prediction control section
80 intra prediction section
90 inter prediction section

1. An image processing device comprising:
a base layer decoding section configured to decode an encoded stream of a base layer, and to generate a reconstructed image of the base layer; and
a prediction control section configured to use the reconstructed image generated by the base layer decoding section, and to control a prediction mode that is selected at generation of a predicted image of an enhancement layer.

2. The image processing device according to claim 1,
wherein the prediction control section uses the reconstructed image to compute a spatial characteristic of the reconstructed image, and controls a prediction mode for intra prediction on the basis of the computed spatial characteristic.

3. The image processing device according to claim 2,
wherein the spatial characteristic includes at least one of a spatial correlation and dispersion of pixel values.

4. The image processing device according to claim 2,
wherein the prediction control section narrows down selectable candidate modes on the basis of the spatial characteristic in a manner that a prediction mode relating to a computation result of the spatial characteristic is included in the candidate modes.

5. The image processing device according to claim 2,
wherein the prediction control section sets a mode number of a prediction mode in a manner that a prediction mode more strongly relating to a computation result of the spatial characteristic has a lower mode number.

6. The image processing device according to claim 1,
wherein the prediction control section includes a prediction mode for inter prediction in a candidate mode that is selectable at generation of the predicted image of the enhancement layer, the prediction mode for inter prediction using a motion vector decided with the reconstructed image.

7. The image processing device according to claim 6,
wherein the prediction control section searches for an optimal motion vector by using the reconstructed image of the base layer and a reference image corresponding to the reconstructed image to decide the motion vector.

8. The image processing device according to claim 6,
wherein the prediction control section adds the prediction mode to a set of candidate modes for inter prediction, the prediction mode using the motion vector decided with the reconstructed image.

9. The image processing device according to claim 6,
wherein the prediction control section replaces the prediction mode with another mode in a set of candidate modes for inter prediction, the prediction mode using the motion vector decided with the reconstructed image.

10. The image processing device according to claim 9,
wherein the other mode is based on a temporal correlation of motion vectors.

11. The image processing device according to claim 7,
wherein the prediction control section does a search in each of prediction blocks having a larger size than a smallest prediction block size used for searching the enhancement layer for a motion vector.

12. The image processing device according to claim 2, further comprising:
a decoding section configured to decode an encoded stream of the enhancement layer in a context-based encoding scheme while switching contexts in accordance with the spatial characteristic of the reconstructed image.

13. The image processing device according to claim 2, further comprising:
an encoding section configured to generate an encoded stream of the enhancement layer in a context-based encoding scheme while switching contexts in accordance with the spatial characteristic of the reconstructed image.

14. The image processing device according to claim 11, further comprising:
a decoding section configured to decode a parameter indicating at least one of the size of the prediction block, and a spatial scope of the prediction block searched by the prediction control section.

15. The image processing device according to claim 11, further comprising:
an encoding section configured to encode a parameter indicating at least one of the size of the prediction block, and a spatial scope of the prediction block searched by the prediction control section.

16. The image processing device according to claim 1, further comprising:
an upsampling section configured to upsample the reconstructed image in accordance with a resolution ratio between the base layer and the enhancement layer,
wherein the prediction control section uses the upsampled reconstructed image to control the prediction mode.

17. The image processing device according to claim 1, further comprising:
a de-interlace section configured to de-interlace the reconstructed image,
wherein the prediction control section uses the de-interlaced reconstructed image to control the prediction mode.

18. The image processing device according to claim 1,
wherein base layer reconstructed pixel only (BLR) scalability is implemented on the base layer and the enhancement layer.

19. An image processing method comprising:
decoding an encoded stream of a base layer, and generating a reconstructed image of the base layer; and
using the generated reconstructed image, and controlling a prediction mode that is selected at generation of a predicted image of an enhancement layer.
